(19) United States
(12) Patent Application Publication
(10) Pub. No.: US 2025/0265786 A1
(43) Pub. Date: Aug. 21, 2025

(54) METADATA-BASED CONTENT LOCKING BEHAVIOR AND OVERRIDING THE SAME

(71) Applicant: Apple Inc., Cupertino, CA (US)

(72) Inventors: Luis R. DELIZ CENTENO, Fremont, CA (US); Rahul NAIR, Hayward, CA (US); Devin W. CHALMERS, Oakland, CA (US); Giancarlo YERKES, San Francisco, CA (US)

(21) Appl. No.: 19/041,423

(22) Filed: Jan. 30, 2025

Related U.S. Application Data
(60) Provisional application No. 63/554,148, filed on Feb. 15, 2024.

(51) Int. Cl. G06T 19/00; G02B 27/01; G06F 3/01; G06T 19/20

(52) U.S. Cl. CPC G06T 19/006; G02B 27/017; G06F 3/012; G06T 19/20; G06T 2219/2004

(57) ABSTRACT

Some examples of the disclosure are directed to systems and methods for presenting virtual content in accordance with metadata that is associated with the virtual content and that indicates (or defines) a content locking behavior for presenting the virtual content. Some examples of the disclosure are directed to systems and methods for presenting virtual content with a content locking behavior that is different from a content locking behavior that is indicated by metadata that is associated with the virtual content.

### CROSS-REFERENCE TO RELATED APPLICATIONS

This application claims the benefit of U.S. Patent Application No. 63/554,148, filed Feb. 15, 2024, the content of which is incorporated herein by reference in its entirety.

### FIELD OF THE DISCLOSURE

This relates generally to systems and methods for presenting virtual content (e.g., visual virtual content), and more particularly to presenting virtual content with a respective content locking behavior in a computer-generated environment.

### BACKGROUND OF THE DISCLOSURE

Some computer graphical environments provide two-dimensional and/or three-dimensional environments where at least some objects displayed for a user's viewing are virtual and generated by a computer. In some examples, the objects are displayed in the three-dimensional environments with particular orientations (e.g., relative to a viewpoint of a user of the computer).

### SUMMARY OF THE DISCLOSURE

Some examples of the disclosure are directed to systems and methods for presenting virtual content in accordance with metadata that is associated with the virtual content and that indicates (or defines) a content locking behavior for presenting the virtual content. In some examples, an electronic device uses respective metadata that indicates a type of content locking behavior for presenting the respective virtual content presented in a three-dimensional environment to determine a manner with which to present the respective virtual content in the three-dimensional environment. In some examples, the metadata indicates multiple content locking behaviors for respective virtual content and a mapping of specific content locking behaviors for the respective virtual content to specific contexts, such as to particular operating conditions of an electronic device. In some examples, the metadata indicates different content locking behaviors with which to present the respective virtual content when different override criteria are satisfied.

Some examples of the disclosure are directed to systems and methods for presenting virtual content with a content locking behavior that is different from a content locking behavior that is indicated by metadata that is associated with the virtual content. In some examples, an electronic device overrides presenting the respective virtual content in accordance with the metadata indicated content locking behavior and presents the respective virtual content in accordance with a content locking behavior that is different from the content locking behavior indicated by the respective metadata.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIGS. 2A-2B illustrate block diagrams of example architectures for electronic devices according to some examples of the disclosure.

FIG. 3A illustrates a block diagram of various types of metadata associated with first virtual content, including a content locking behavior, according to some examples of the disclosure.

FIG. 3B illustrates a block diagram of various types of content locking behaviors according to some examples of the disclosure.

FIG. 3C illustrates a block diagram showing first virtual content transitioning between a first content locking behavior and a second content locking behavior, optionally in accordance with an override input, according to some examples of the disclosure.

FIG. 3D illustrates a flowchart of a method for initiating a process to display virtual content in accordance with a detected override input, according to some examples of the disclosure.

FIGS. 4A-4C illustrate first virtual content that is head-locked with elasticity, according to some examples of the disclosure.

FIGS. 5A-5B illustrate first virtual content that is body-locked and, alternatively, illustrates first virtual content transitioning from a content locking behavior that is head-locked to a content locking behavior that is body-locked, according to some examples of the disclosure.

FIGS. 6A-6B illustrate a resetting of a placement and/or orientation of first virtual content, according to some examples of the disclosure.

FIGS. 7A-7D illustrate first virtual content that is head-locked, according to some examples of the disclosure.

FIGS. 8A-8C illustrate alternative content locking behavior transitions of first virtual content, according to some examples of the disclosure.

FIG. 9 illustrates a flowchart of a method for presenting virtual content in accordance with metadata that is associated with the virtual content, according to some examples of the disclosure.

### DETAILED DESCRIPTION

Some examples of the disclosure are directed to systems and methods for presenting virtual content in accordance with metadata that is associated with the virtual content and that indicates (or defines) a content locking behavior for presenting the virtual content. In some examples, an electronic device uses respective metadata that indicates a type of content locking behavior for presenting the respective virtual content presented in a three-dimensional environment to determine a manner with which to present the respective virtual content in the three-dimensional environment. In some examples, the metadata indicates multiple content locking behaviors for respective virtual content and a mapping of specific content locking behaviors for the respective virtual content to specific contexts, such as to particular operating conditions of an electronic device. In some examples, the metadata indicates different content locking behaviors with which to present the respective virtual content when different override criteria are satisfied.

Some examples of the disclosure are directed to systems and methods for presenting virtual content with a content locking behavior that is different from a content locking behavior that is indicated by metadata that is associated with the virtual content. In some examples, an electronic device overrides presenting the respective virtual content in accordance with the metadata indicated content locking behavior and presents the respective virtual content in accordance with a content locking behavior that is different from the content locking behavior indicated by the respective metadata.

In some examples, a three-dimensional object is displayed in a computer-generated three-dimensional environment with a particular orientation that controls one or more behaviors of the three-dimensional object (e.g., when the three-dimensional object is moved within the three-dimensional environment). In some examples, the orientation in which the three-dimensional object is displayed in the three-dimensional environment is selected by a user of the electronic device or automatically selected by the electronic device. For example, when initiating presentation of the three-dimensional object in the three-dimensional environment, the user may select a particular orientation for the three-dimensional object or the electronic device may automatically select the orientation for the three-dimensional object (e.g., based on a type of the three-dimensional object).

In some examples, a three-dimensional object can be displayed in the three-dimensional environment in a world-locked orientation, a body-locked orientation, a tilt-locked orientation, or a head-locked orientation, as described below. As used herein, an object that is displayed in a body-locked orientation in a three-dimensional environment has a distance and orientation offset relative to a portion of the user's body (e.g., the user's torso). Alternatively, in some examples, a body-locked object has a fixed distance from the user without the orientation of the content being referenced to any portion of the user's body (e.g., may be displayed in the same cardinal direction relative to the user, regardless of head and/or body movement). Additionally or alternatively, in some examples, the body-locked object may be configured to always remain gravity or horizon (e.g., normal to gravity) aligned, such that head and/or body changes in the roll direction would not cause the body-locked object to move within the three-dimensional environment. Rather, translational movement in either configuration would cause the body-locked object to be repositioned within the three-dimensional environment to maintain the distance offset.

As used herein, an object that is displayed in a head-locked orientation in a three-dimensional environment has a distance and orientation offset relative to the user's head. In some examples, a head-locked object moves within the three-dimensional environment as the user's head moves (as the viewpoint of the user changes).

As used herein, an object that is displayed in a world-locked orientation in a three-dimensional environment does not have a distance or orientation offset relative to the user.

As used herein, an object that is displayed in a tilt-locked orientation in a three-dimensional environment (referred to herein as a tilt-locked object) has a distance offset relative to the user, such as a portion of the user's body (e.g., the user's torso) or the user's head. In some examples, a tilt-locked object is displayed at a fixed orientation relative to the three-dimensional environment. In some examples, a tilt-locked object moves according to a polar (e.g., spherical) coordinate system centered at a pole through the user (e.g., the user's head). For example, the tilt-locked object is moved in the three-dimensional environment based on movement of the user's head within a spherical space surrounding (e.g., centered at) the user's head. Accordingly, if the user tilts their head (e.g., upward or downward in the pitch direction) relative to gravity, the tilt-locked object would follow the head tilt and move radially along a sphere, such that the tilt-locked object is repositioned within the three-dimensional environment to be the same distance offset relative to the user as before the head tilt while optionally maintaining the same orientation relative to the three-dimensional environment. In some examples, if the user moves their head in the roll direction (e.g., clockwise or counterclockwise) relative to gravity, the tilt-locked object is not repositioned within the three-dimensional environment.

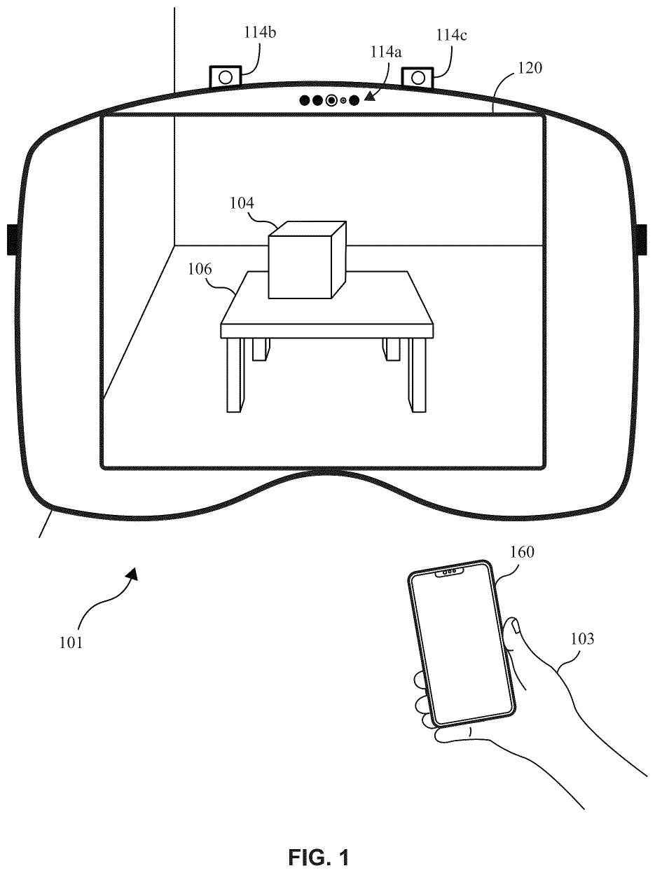

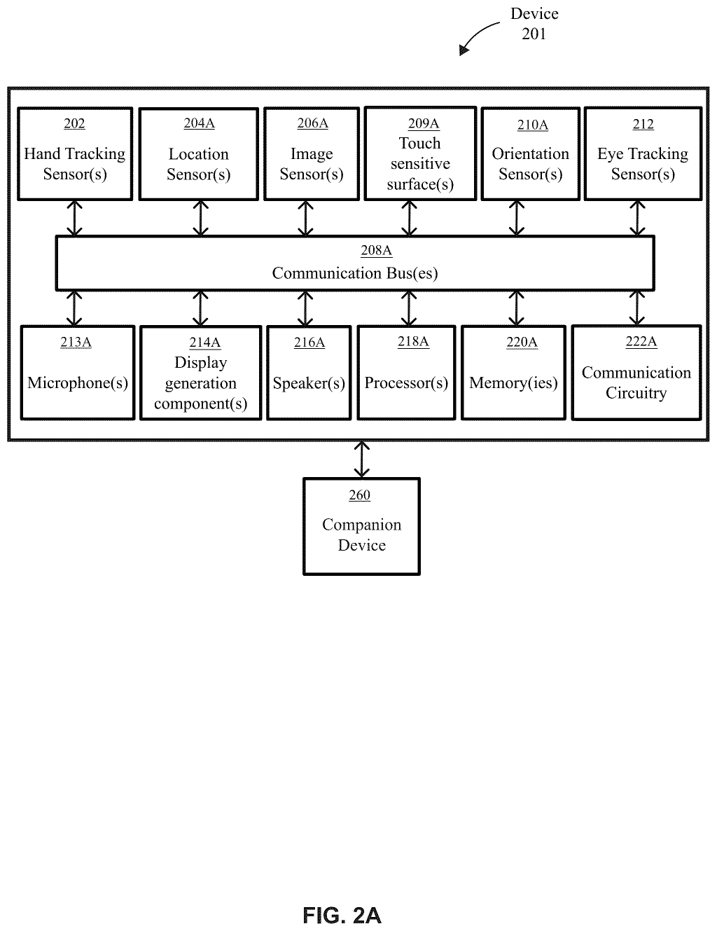

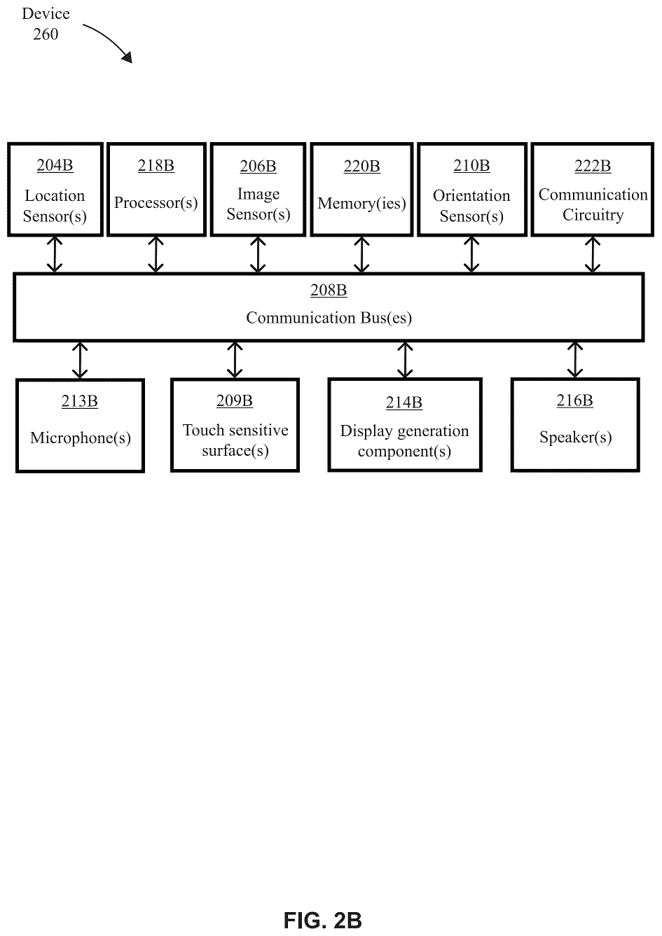

FIG. 1 illustrates an electronic device 101 presenting an extended reality (XR) environment (e.g., a computer-generated environment optionally including representations of physical and/or virtual objects) according to some examples of the disclosure. In some examples, as shown in FIG. 1, electronic device 101 is a head-mounted display or other head-mountable device configured to be worn on a head of a user of electronic device 101. In some examples, electronic device 101 is a system including smart goggles or smart glasses. Examples of electronic device 101 are described below with reference to the architecture block diagram of FIG. 2A. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of physical environment including table 106 (illustrated in the field of view of electronic device 101).

In some examples, as shown in FIG. 1, electronic device 101 includes one or more internal image sensors 114a oriented towards a face of the user (e.g., eye tracking cameras described below with reference to FIGS. 2A-2B). In some examples, internal image sensors 114a are used for eye tracking (e.g., detecting a gaze of the user). Internal image sensors 114a are optionally arranged on the left and right portions of display 120 (e.g., a display generation component) to enable eye tracking of the user's left and right eyes. In some examples, electronic device 101 also includes external image sensors 114b and 114c facing outwards from the user to detect and/or capture the physical environment of electronic device 101 and/or movements of the user's hands or other body parts.

In some examples, display 120 has a field of view visible to the user (e.g., that may or may not correspond to a field of view of external image sensors 114b and 114c). Because display 120 is optionally part of a head-mounted device, the field of view of display 120 is optionally the same as or similar to the field of view of the user's eyes. In other examples, the field of view of display 120 may be smaller than the field of view of the user's eyes. In some examples, electronic device 101 may be an optical see-through device in which display 120 is a transparent or translucent display through which portions of the physical environment may be directly viewed. In some examples, display 120 may be included within a transparent lens and may overlap all or only a portion of the transparent lens. In other examples, electronic device may be a video-passthrough device in which display 120 is an opaque display configured to display images of the physical environment captured by external image sensors 114b and 114c. While a single display 120 is shown, it should be appreciated that display 120 may include a stereo pair of displays.

In some examples, in response to a trigger, electronic device 101 may be configured to display a virtual object 104 in the XR environment represented by a cube illustrated in FIG. 1, which is not present in the physical environment, but is displayed in the XR environment positioned on the top of real-world table 106 (or a representation thereof). Optionally, virtual object 104 can be displayed on the surface of table 106 in the XR environment displayed via the display 120 of electronic device 101 in response to detecting the planar surface of table 106 in the physical environment 100.

It should be understood that virtual object 104 is a representative virtual object and one or more different virtual objects (e.g., of various dimensionality such as two-dimensional or other three-dimensional virtual objects) can be included and rendered in a three-dimensional XR environment. For example, the virtual object can represent an application or a user interface displayed in the XR environment. In some examples, the virtual object can represent content corresponding to the application and/or displayed via the user interface in the XR environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

In some examples, electronic device 101 may be configured to communicate with a second electronic device, such as a companion device. For example, as illustrated in FIG. 1, electronic device 101 may be in communication with electronic device 160. In some examples, electronic device 160 corresponds to a mobile electronic device, such as a smartphone, a tablet computer, a smart watch, or other electronic device. Additional examples of electronic device 160 are described below with reference to the architecture block diagram of FIG. 2B. In some examples, electronic device 101 and electronic device 160 are associated with a same user. For example, in FIG. 1, electronic device 101 may be positioned (e.g., mounted) on a head of a user and electronic device 160 may be positioned near electronic device 101, such as in a hand 103 of the user (e.g., the hand 103 is holding of electronic device 160), and electronic device 101 and electronic device 160 are associated with a same user account of the user (e.g., the user is logged into the user account on electronic device 101 and electronic device 160). Additional details regarding the communication between electronic device 101 and electronic device 160 are provided below with reference to FIGS. 2A-2B.

In some examples, displaying an object in a three-dimensional environment may include interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the discussion that follows, an electronic device that is in communication with a display and one or more input devices is described. It should be understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIGS. 2A-2B illustrate block diagrams of example architectures for electronic devices 201 and 260 according to some examples of the disclosure. In some examples, electronic device 201 and/or electronic device 260 include one or more electronic devices. For example, the electronic device 201 may be a portable device, an auxiliary device in communication with another device, a head-mounted display, etc., respectively. In some examples, electronic device 201 corresponds to electronic device 101 described above with reference to FIG. 1. In some examples, electronic device 260 corresponds to electronic device 160 described above with reference to FIG. 1.

As illustrated in FIG. 2A, the electronic device 201 optionally includes various sensors, such as one or more hand tracking sensors 202, one or more location sensors 204A, one or more image sensors 206A (optionally corresponding to internal image sensors 114a and/or external image sensors 114b and 114c in FIG. 1), one or more touch-sensitive surfaces 209A, one or more motion and/or orientation sensors 210A, one or more eye tracking sensors 212, one or more microphones 213A or other audio sensors, one or more body tracking sensors (e.g., torso and/or head tracking sensors), one or more display generation components 214A, optionally corresponding to display 120 in FIG. 1, one or more speakers 216A, one or more processors 218A, one or more memories 220A, and/or communication circuitry 222A. One or more communication buses 208A are optionally used for communication between the above-mentioned components of electronic devices 201. Additionally, as shown in FIG. 2B, the electronic device 260 optionally includes one or more location sensors 204B, one or more image sensors 206B, one or more touch-sensitive surfaces 209B, one or more orientation sensors 210B, one or more microphones 213B, one or more display generation components 214B, one or more speakers 216B, one or more processors 218B, one or more memories 220B, and/or communication circuitry 222B. One or more communication buses 208B are optionally used for communication between the above-mentioned components of electronic device 260. The electronic devices 201 and 260 are optionally configured to communicate via a wired or wireless connection (e.g., via communication circuitry 222A, 222B) between the two electronic devices. For example, as indicated in FIG. 2A, the electronic device 260 may function as a companion device to the electronic device 201.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®.

Processor(s) 218A, 218B include one or more general processors, one or more graphics processors, and/or one or more digital signal processors. In some examples, memory 220A or 220B is a non-transitory computer-readable storage medium (e.g., flash memory, random access memory, or other volatile or non-volatile memory or storage) that stores computer-readable instructions configured to be executed by processor(s) 218A, 218B to perform the techniques, processes, and/or methods described below. In some examples, memory 220A and/or 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, display generation component(s) 214A, 214B include a single display (e.g., a liquid-crystal display (LCD), organic light-emitting diode (OLED), or other types of display). In some examples, display generation component(s) 214A, 214B includes multiple displays. In some examples, display generation component(s) 214A, 214B can include a display with touch capability (e.g., a touch screen), a projector, a holographic projector, a retinal projector, a transparent or translucent display, etc. In some examples, electronic devices 201 and 260 include touch-sensitive surface(s) 209A and 209B, respectively, for receiving user inputs, such as tap inputs and swipe inputs or other gestures. In some examples, display generation component(s) 214A, 214B and touch-sensitive surface(s) 209A, 209B form touch-sensitive display(s) (e.g., a touch screen integrated with each of electronic devices 201 and 260 or external to each of electronic devices 201 and 260 that is in communication with each of electronic devices 201 and 260).

Electronic devices 201 and 260 optionally includes image sensor(s) 206A and 206B, respectively. Image sensors(s) 206A, 206B optionally include one or more visible light image sensors, such as charged coupled device (CCD) sensors, and/or complementary metal-oxide-semiconductor (CMOS) sensors operable to obtain images of physical objects from the real-world environment. Image sensor(s) 206A, 206B also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206A, 206B also optionally include one or more cameras configured to capture movement of physical objects in the real-world environment. Image sensor(s) 206A, 206B also optionally include one or more depth sensors configured to detect the distance of physical objects from electronic device 201, 260. In some examples, information from one or more depth sensors can allow the device to identify and differentiate objects in the real-world environment from other objects in the real-world environment. In some examples, one or more depth sensors can allow the device to determine the texture and/or topography of objects in the real-world environment.

In some examples, electronic device 201, 260 uses CCD sensors, event cameras, and depth sensors in combination to detect the physical environment around electronic device 201, 260. In some examples, image sensor(s) 206A, 206B include a first image sensor and a second image sensor. The first image sensor and the second image sensor work in tandem and are optionally configured to capture different information of physical objects in the real-world environment. In some examples, the first image sensor is a visible light image sensor and the second image sensor is a depth sensor. In some examples, electronic device 201, 260 uses image sensor(s) 206A, 206B to detect the position and orientation of electronic device 201, 260 and/or display generation component(s) 214A, 214B in the real-world environment. For example, electronic device 201, 260 uses image sensor(s) 206A, 206B to track the position and orientation of display generation component(s) 214A, 214B relative to one or more fixed objects in the real-world environment.

In some examples, electronic devices 201 and 260 include microphone(s) 213A and 213B, respectively, or other audio sensors. Electronic device 201, 260 optionally uses microphone(s) 213A, 213B to detect sound from the user and/or the real-world environment of the user. In some examples, microphone(s) 213A, 213B includes an array of microphones (a plurality of microphones) that optionally operate in tandem, such as to identify ambient noise or to locate the source of sound in space of the real-world environment.

Electronic devices 201 and 260 include location sensor(s) 204A and 204B, respectively, for detecting a location of electronic device 201A and/or display generation component(s) 214A and a location of electronic device 260 and/or display generation component(s) 214B, respectively. For example, location sensor(s) 204A, 204B can include a global positioning system (GPS) receiver that receives data from one or more satellites and allows electronic device 201, 260 to determine the device's absolute position in the physical world.

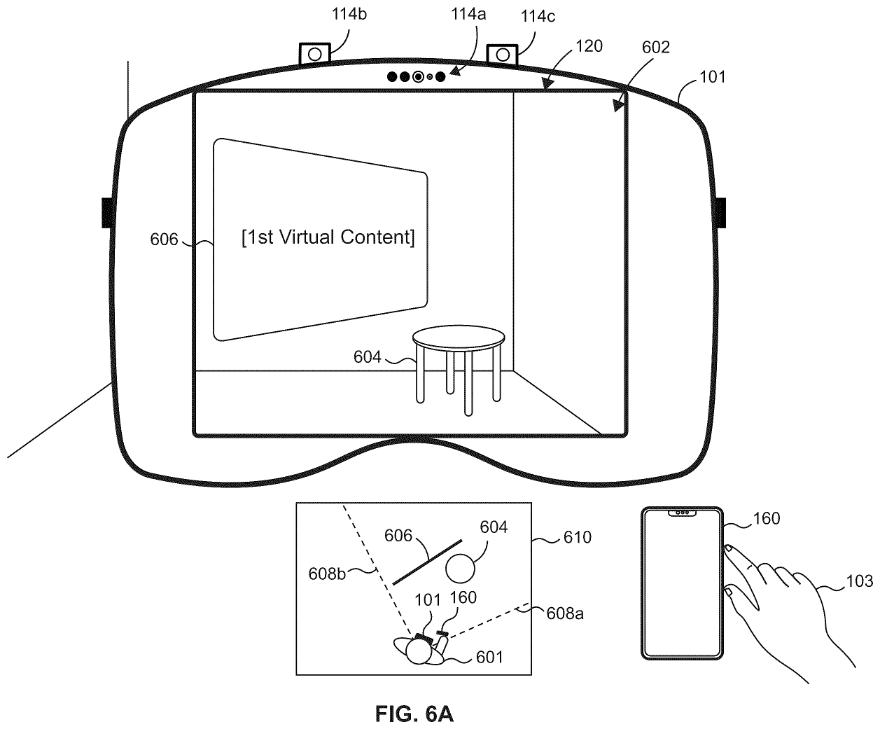

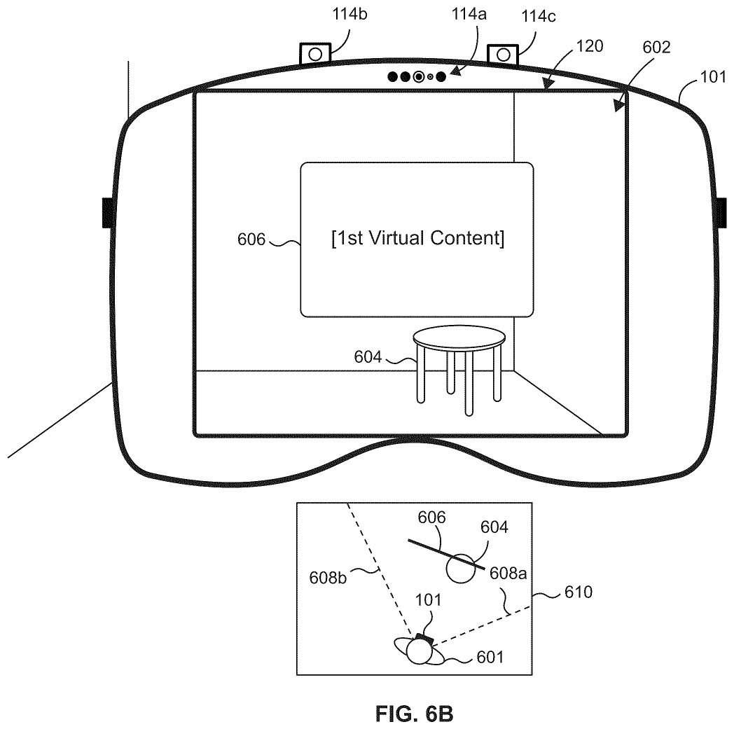

Electronic devices 201 and 260 include orientation sensor(s) 210A and 210B, respectively, for detecting orientation and/or movement of electronic device 201 and/or display generation component(s) 214A and orientation and/or movement of electronic device 260 and/or display generation component(s) 214B, respectively. For example, electronic device 201, 260 uses orientation sensor(s) 210A, 210B to track changes in the position and/or orientation of electronic device 201, 260 and/or display generation component(s) 214A, 214B, such as with respect to physical objects in the real-world environment. Orientation sensor(s) 210A, 210B optionally include one or more gyroscopes and/or one or more accelerometers. Data from orientation sensor(s) 210A, 210B are optionally used to determine whether to reposition or recenter first virtual content, such as described with reference to FIGS. 6A-6B.

Electronic device 201 includes hand tracking sensor(s) 202 and/or eye tracking sensor(s) 212 (and/or other body tracking sensor(s), such as leg, torso and/or head tracking sensor(s)), in some examples. Hand tracking sensor(s) 202 are configured to track the position/location of one or more portions of the user's hands, and/or motions of one or more portions of the user's hands with respect to the extended reality environment, relative to the display generation component(s) 214A, and/or relative to another defined coordinate system. Eye tracking sensor(s) 212 are configured to track the position and movement of a user's gaze (eyes, face, or head, more generally) with respect to the real-world or extended reality environment and/or relative to the display generation component(s) 214A. In some examples, hand tracking sensor(s) 202 and/or eye tracking sensor(s) 212 are implemented together with the display generation component(s) 214A. In some examples, the hand tracking sensor(s) 202 and/or eye tracking sensor(s) 212 are implemented separate from the display generation component(s) 214A. In some examples, electronic device 201 alternatively does not include hand tracking sensor(s) 202 and/or eye tracking sensor(s) 212. In some such examples, the display generation component(s) 214A may be utilized by the electronic device 260 to provide an extended reality environment and utilize input and other data gathered via the other sensor(s) (e.g., the one or more location sensors 204A, one or more image sensors 206A, one or more touch-sensitive surfaces 209A, one or more motion and/or orientation sensors 210A, and/or one or more microphones 213A or other audio sensors) of the electronic device 201 as input and data that is processed by the processor(s) 218B of the electronic device 260.

In some examples, the hand tracking sensor(s) 202 (and/or other body tracking sensor(s), such as leg, torso and/or head tracking sensor(s)) can use image sensor(s) 206 (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, one or more image sensors 206A are positioned relative to the user to define a field of view of the image sensor(s) 206A and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, eye tracking sensor(s) 212 includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic devices 201 and 260 are not limited to the components and configuration of FIGS. 2A-2B, but can include fewer, other, or additional components in multiple configurations. In some examples, electronic device 201 and/or electronic device 260 can each be implemented between multiple electronic devices (e.g., as a system). In some such examples, each of (or more) electronic device may each include one or more of the same components discussed above, such as various sensors, one or more display generation components, one or more speakers, one or more processors, one or more memories, and/or communication circuitry. A person or persons using electronic device 201 and/or electronic device 260, is optionally referred to herein as a user or users of the device.

Attention is now directed towards interactions with one or more virtual objects that are displayed in a three-dimensional environment presented at an electronic device (e.g., corresponding to electronic device 101). In some examples, the electronic device uses respective metadata that indicates a type of content locking behavior of respective virtual content presented in the three-dimensional environment to determine a manner with which to present the respective virtual content in the three-dimensional environment. In some examples, the respective metadata that indicates the type of content locking behavior of respective virtual content associated with the metadata can be overridden, such that the electronic device displays or causes display of the respective virtual content with a content locking behavior that is different from the content locking behavior indicated by the respective metadata.

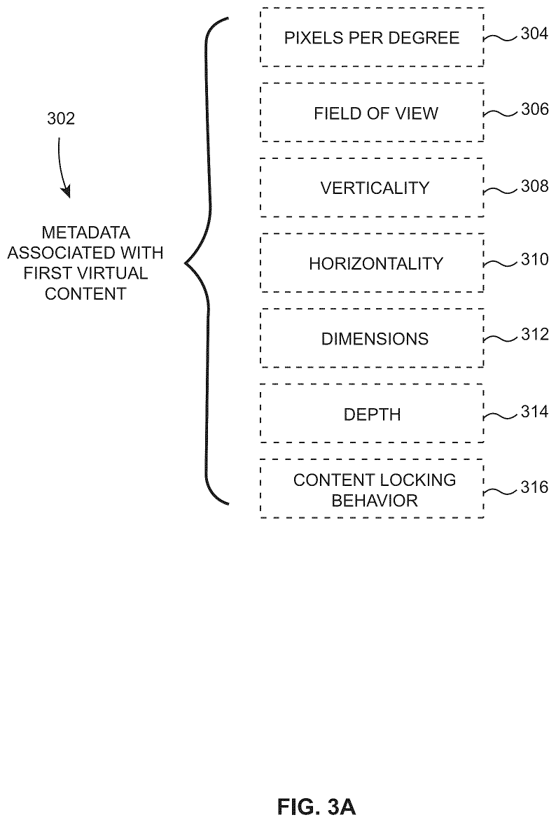

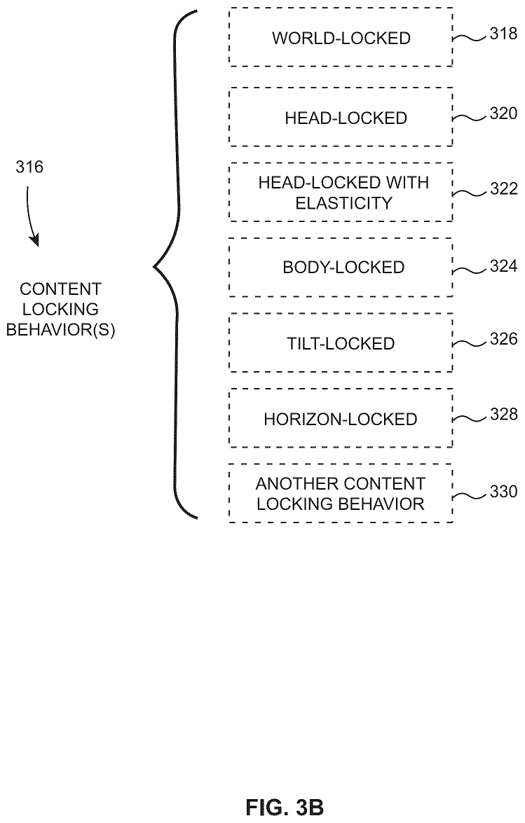

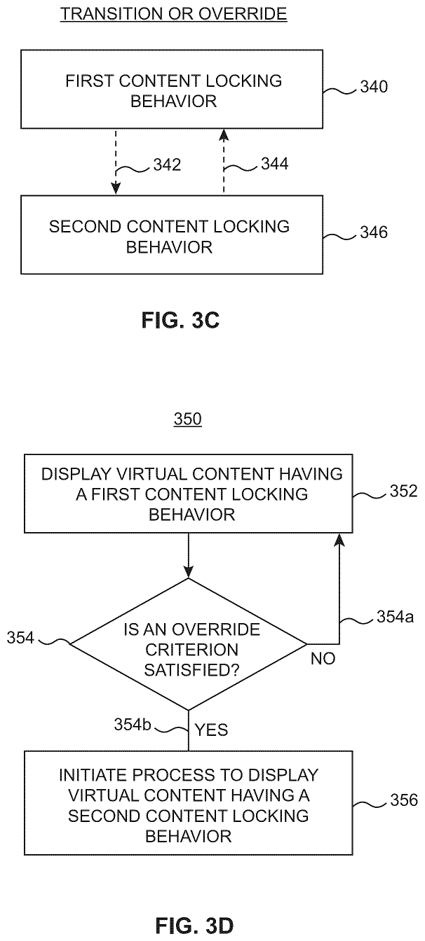

FIG. 3A illustrates a block diagram of various types of metadata associated with first virtual content, including a content locking behavior, according to some examples of the disclosure.

Metadata can include data that provides details (e.g., descriptions, definitions, indications, instructions, information, etc.) about other data. In some examples, metadata associated with a software application is programmed by a software application developer. In some examples, processor(s) of an electronic device presents an instance or object of the software application, such as a user interface of an application in accordance with the metadata associated with the software application.

Metadata associated with first virtual content optionally indicates (or defines) parameters (e.g., preferred parameters), such as display parameters, related to presentation of first virtual content in a three-dimensional environment. In some examples, an electronic device uses metadata to determine the manner in which to present first virtual content in a three-dimensional environment. In some examples, an electronic device presents first virtual content based on the metadata associated with the first virtual content, such as described below.

As shown in FIG. 3A, in some examples, the metadata associated with the first virtual content optionally indicates (or defines) a pixels per degree 304 (PPD) associated with the display of the first virtual content (e.g., a preferred PPD). For example, PPD optionally refers to the resolution of an image in terms of a number of pixels that are visible within one degree of the viewer's visual field of view (e.g., a field of view of the electronic device). In some examples, the metadata associated with the first virtual content optionally defines a preferred amount of PPD for displaying the first virtual content, optionally for optimal interaction and/or display of features of first virtual content. For example, a software application developer or other content provider optionally indicates a preferred PPD for viewing the first virtual content, and the electronic device optionally accesses such information to determine the manner with which to present first virtual content.

As shown in FIG. 3A, in some examples, the metadata associated with the first virtual content optionally indicates (or defines) a field of view (FoV) 306 associated with the display of the first virtual content (e.g., preferred FoV). For example, the FoV of the metadata optionally defines a preferred field of view of display 120 and/or of the display of the first virtual content via display 120. In some examples, the FoV of the metadata indicates an area or volume of the field of view of the user that is to be consumed by the display of the first virtual content via display 120. In some examples, the preferred FoV is defined as a function of time. For example, display of the first virtual content is optionally playback of a movie, and the metadata associated with the movie optionally indicates that the media is to be consumed with a first FoV at a first timestamp of the movie, and is to be consumed with a second FoV, different from the FoV (e.g., greater than or less than the first FoV), at a second timestamp within the playback of the movie, different from the first timestamp within the playback of the movie. In some examples, pixels per degree 304 is defined relative to the field of view 306.

As shown in FIG. 3A, in some examples, the metadata associated with the first virtual content optionally indicates (or defines) a verticality 308 (e.g., a preferred verticality) associated with display of first virtual content in a three-dimensional environment. For example, verticality 308 of the metadata optionally defines a height of the first virtual content (e.g., a vertical position associated with the display of the first virtual content and/or a vertical position associated with a center position of the display of the first virtual content). For example, verticality 308 optionally indicates that the first virtual content is to be displayed at a first vertical position within the computer-generated environment, optionally relative to FoV 306. Further, verticality 308 optionally defines a vertical maximum and/or a vertical minimum at which the first virtual content is to be displayed via display 120 (e.g., a maximum and/or minimum vertical pixel position via which the first virtual content is to be displayed via display 120).

As shown in FIG. 3A, in some examples, the metadata associated with the first virtual content optionally indicates (or defines) a horizontality 310 (e.g., a preferred horizontality) associated with the display of the first virtual content. For example, horizontality 310 of the metadata optionally defines a preferred horizontal position of the first virtual content (e.g., a horizontal position associated with the display of the first virtual content and/or a lateral position associated with a center position of the display of the first virtual content). For example, horizontality 310 optionally defines a horizontal maximum and/or horizontal minimum at which the first virtual content is to be displayed in three-dimensional environment via display 120 (e.g., a maximum and/or minimum horizontal pixel position via which the first virtual content is to be displayed via display 120).

As shown in FIG. 3A, in some examples, the metadata associated with the first virtual content optionally indicates (or defines) one or more dimensions 312 of the presentation of the first virtual content in a three-dimensional environment (e.g., preferred quantities of dimensions). For example, the dimensions 312 optionally defines a preferred length, width, and/or height of the first virtual content within a three-dimensional environment or within the viewpoint of the user and/or relative to the viewpoint of the user.

As shown in FIG. 3A, in some examples, the metadata associated with the first virtual content optionally indicates (or defines) a depth 314 (e.g., a preferred depth) associated with the display of the first virtual content. For example, depth 314 optionally refers to a distance (e.g., a perceived distance) between the location of the first virtual content and the position associated with the user (e.g., the viewpoint of electronic device 101).

As shown in FIG. 3A, in some examples, the metadata associated with the first virtual content optionally indicates (or defines) a content locking behavior 316 (e.g., a preferred content locking behavior) associated with the display of the first virtual content, such as described below with reference to FIG. 3B.

FIG. 3B illustrates a block diagram of various types of content lock behaviors according to some examples of the disclosure. For example, metadata associated with the first virtual content optionally indicates (or defines) any one of the content locking behaviors 316 shown in FIG. 3B as a preferred content locking behavior. As another example, electronic device 101 optionally displays first virtual content in accordance with one of the content locking behaviors 316 even when the one of the content locking behaviors is not indicated by the metadata associated with the first virtual content (e.g., optionally because electronic device 101 (or electronic device 160) an override criterion is satisfied, such as described below with reference to FIG. 3D.

As shown in FIG. 3B, one content locking behavior 316 is world-locked 318. For example, when the content locking behavior of the first virtual content is world-locked, first virtual content does not have a distance or orientation offset relative to the user, such as described above with reference to a world-locked object.

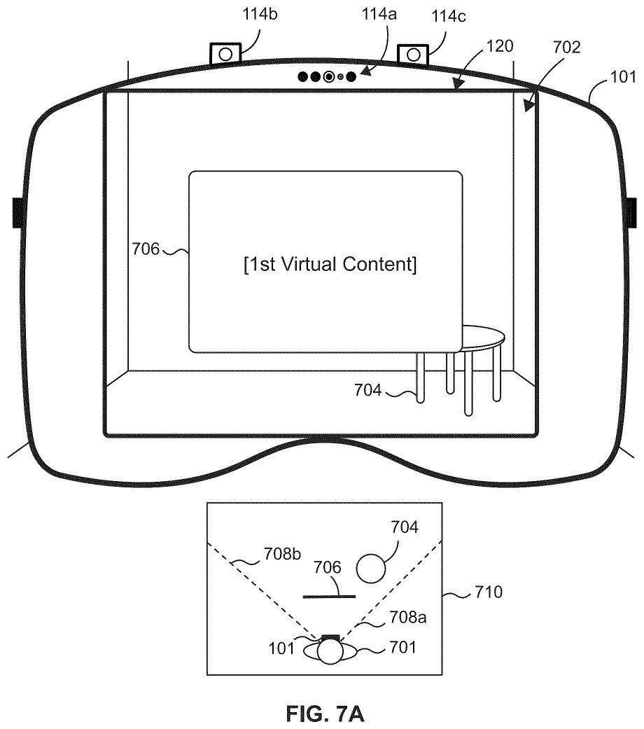

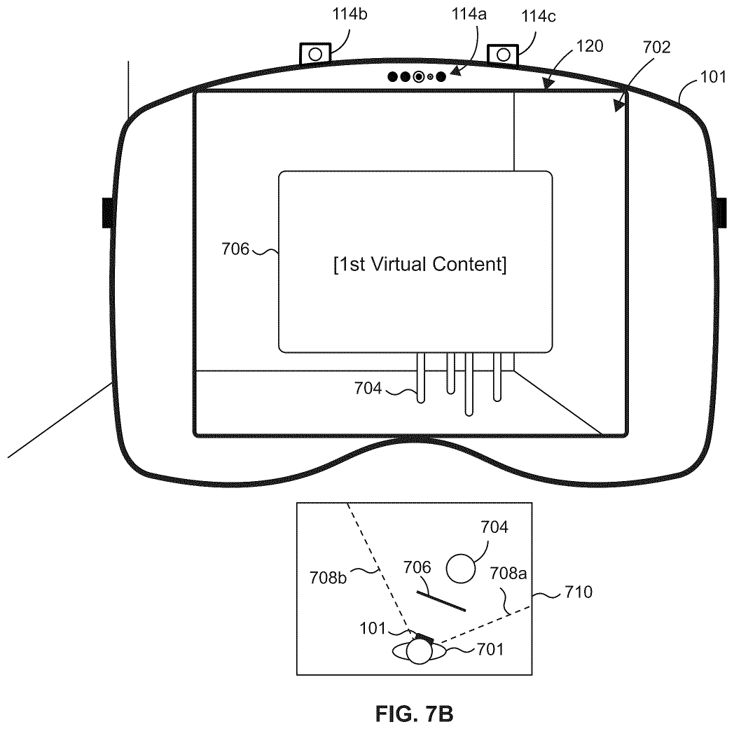

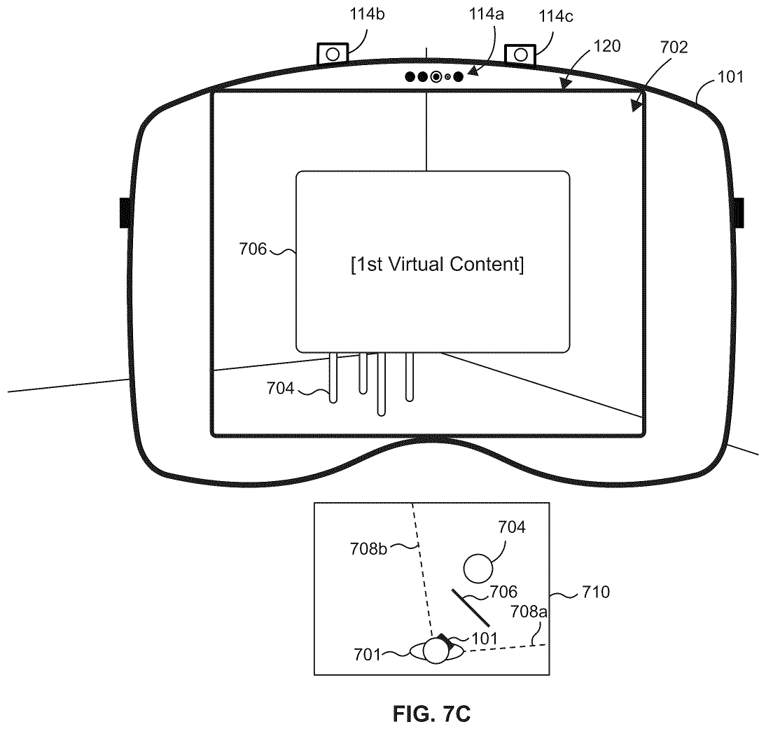

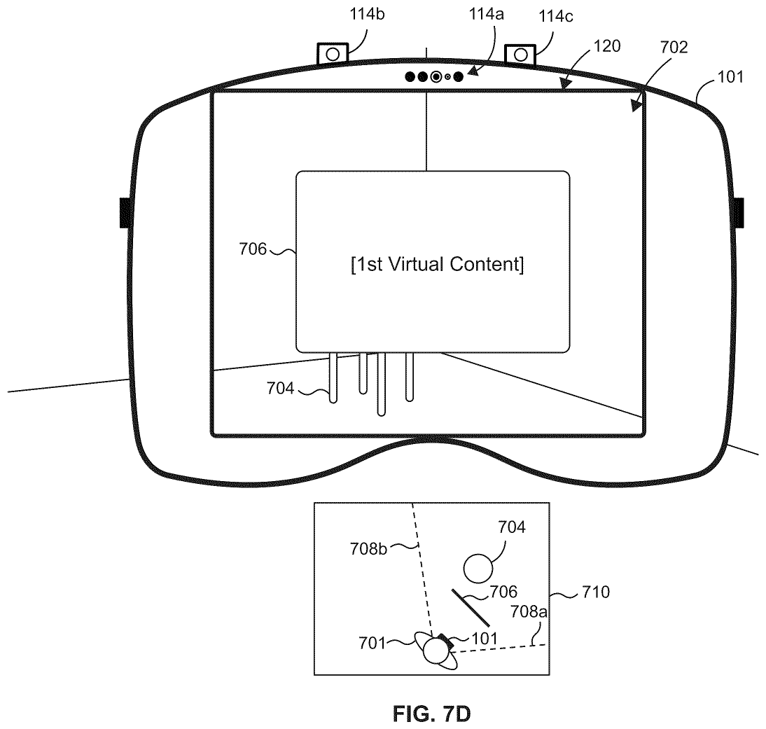

As shown in FIG. 3B, one content locking behavior 316 is head-locked 320. For example, when the content locking behavior of the first virtual content is head-locked, first virtual content optionally visually behaves as head-locked content, such as described herein relative to an object that is displayed in a head-locked orientation in a three-dimensional environment and/or such as a head-locked object. For example, when the content locking behavior of the first virtual content is head-locked, and in accordance with detection of head movement, electronic device 101 optionally displays the first virtual content moving within a three-dimensional environment in accordance with the user's head movement, optionally in order to maintain (e.g., lock) a position of first virtual content on display 120 and distance of the first virtual content relative to the head of the user. As another example, when head-locked, the first virtual content is locked to (e.g., displayed via) a first set of pixels (e.g., a predefined number or area of pixels) on display 120 without being locked to (e.g., displayed via) a second set of pixels, such that the first virtual content is maintained on display 120 via the first set of pixels even when the user's moves the user's head. As another example, when content locking behavior of the first virtual content is head-locked, movement of display 120 optionally results in movement of the first virtual content relative to a physical environment of electronic device 101, such as shown and described below with reference to FIGS. 7A-7D.

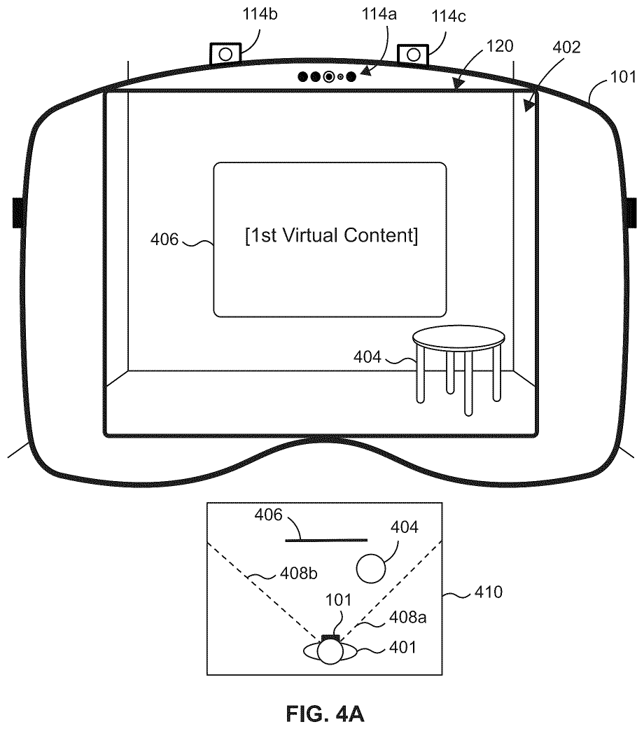

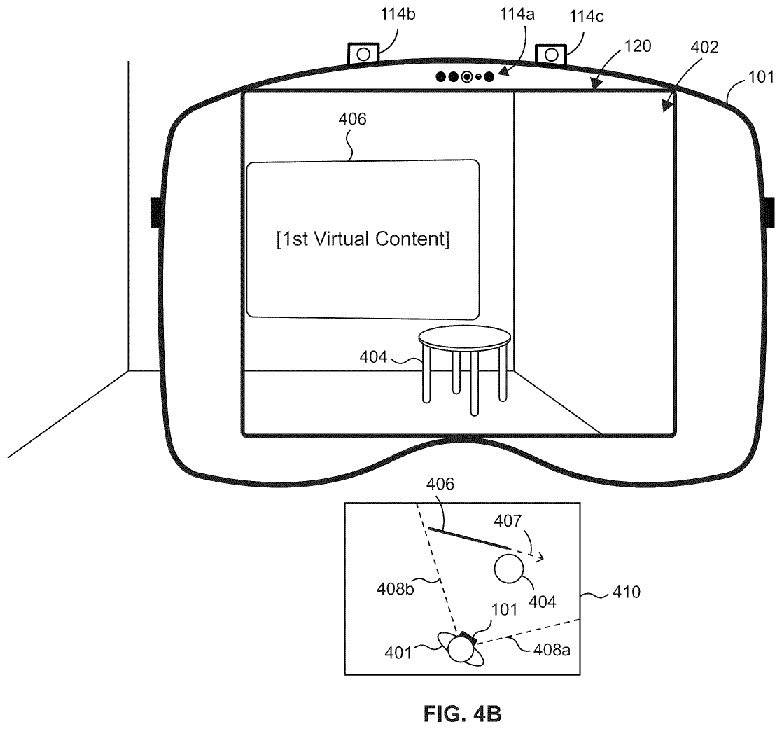

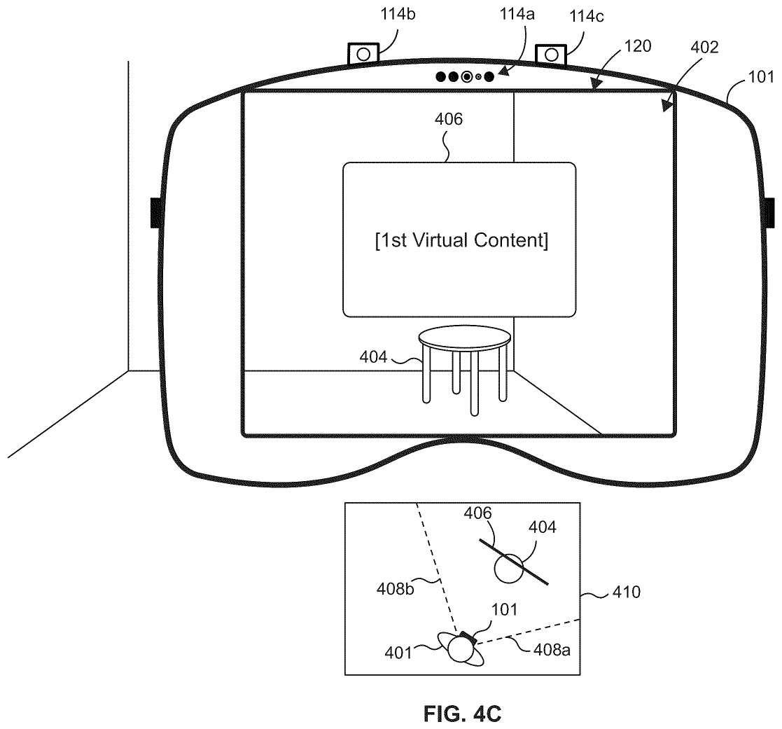

As shown in FIG. 3B, one content locking behavior 316 is head-locked with elasticity 322. For example, when the content locking behavior of the first virtual content is head-locked with elasticity, electronic device 101 optionally causes the first virtual content to visually behave as head-locked content in accordance with an elasticity model. In some examples, the elasticity model implements physics to the user's interaction in the virtual environment so that the interaction is governed by the law of physics, such by laws relating to springs. For example, the head position and/or head orientation of the user optionally corresponds to a location of a first end of a spring (e.g., simulating a first end of the spring being attached to an object) and the first virtual content optionally corresponds to a mass attached to a second end of the spring, different from (e.g., opposite) the first end of the spring. While the head position and/or orientation is a first head position and/or first orientation that corresponds to a first location of the first end of the spring and the first virtual content corresponds to the mass attached to the second end of the spring, the electronic device optionally detects head movement (e.g., head rotation) from the first head position and/or first head orientation to a second head position and/or second head orientation. In response to the detection of the head rotation, the electronic device optionally models deformity of the spring (e.g., in accordance with the amount of head rotation and/or speed of head rotation), and moves the first virtual content in accordance with release of the energy that is due to the spring's movement toward an equilibrium position (e.g., a stable equilibrium position) relative to the second head position and/or second head orientation. The speed at which the first virtual content follows the head rotation is optionally a function of the distance between the location of the first virtual content when the electronic device detects the head rotation and the location of the first virtual content that would correspond to a relaxed position of the spring (e.g., an equilibrium position), which would optionally be a location, that, relative to the user's new viewpoint resulting from the head rotation, is the same as the location of first virtual content relative to the user's viewpoint before the head rotation is detected. In some examples, as the first virtual content moves towards to the relaxed position in response to the head rotation, the speed of the first virtual content decreases. In some examples, the head of the user is rotated a first amount within a first amount of time, and the movement of the first virtual content to its new location relative to the new viewpoint of the user is performed within a second amount of time that is greater than the first amount of time. As such, when the content locking behavior of the first virtual content is head-locked with elasticity 322, in accordance with detection of head movement, electronic device 101 optionally displays the first virtual content moving within a three-dimensional environment in accordance with the user's head movement and in accordance with an elasticity model mimicking a lazy follow movement behavior, such as shown and described with reference to FIGS. 4A-4C. Head-locked with elasticity 322 is optionally useful for smoothing out the movement of the first virtual content in the three-dimensional environment when the user moves (e.g., rotates the user's head).

As shown in FIG. 3B, one content locking behavior 316 is body-locked 324. For example, when the content locking behavior of first virtual content is body-locked, electronic device 101 optionally causes the first virtual content to visually behave as body-locked content, such as described herein with reference to an object that is displayed in a body-locked orientation in a three-dimensional environment and/or a body-locked object. For example, when the content locking behavior of the first virtual content is body-locked, electronic device 101 optionally does not display the first virtual content moving within the three-dimensional environment in accordance with user's head rotation (e.g., head rotation of the user optionally does cause the electronic device to reposition first virtual content in three-dimensional environment), but rather in accordance with the user's torso movement or rotation.

As shown in FIG. 3B, one content locking behavior 316 is tilt-locked 326. For example, when the content locking behavior of the first virtual content is tilt-locked, such as described above with reference to a tilt-locked object, as defined above.

As shown in FIG. 3B, one content locking behavior 316 is horizon-locked 328. For example, when the content locking behavior of first virtual content is horizon-locked 328, electronic device 101 optionally causes the first virtual content to visually behave as if bound to a horizon line or eye level. For example, when the eye level of the user of electronic device 101 is a first eye level (e.g., 4 ft, 5 ft, 6 ft, 6.5 ft, or another height in an environment that is or is approximately the same height as the eyes of the user and/or of the height of display 120 relative to the ground (e.g., a floor) of the physical environment of the user), electronic device 101 optionally causes the first virtual content to visually behave as if bound to the first eye level (e.g., a center of first virtual content intersects with a horizontal line corresponding to the first eye level in the environment and optionally continues to intersect with the first eye level), and when the eye level of the user of electronic device 101 is a second eye level, different from the first eye level, electronic device 101 optionally causes the first virtual content to visually behave as if bound to the second eye level (e.g., a center of the first virtual content intersects with a horizontal line corresponding to the second eye level and optionally continues to intersect with the second eye level). As another example, when the content locking behavior of first virtual content is horizon-locked 328, the first virtual content optionally remains aligned to a horizon relative to a given user's eye level. For example, the electronic device optionally positions the first virtual content at a height that is aligned with the horizon relative to the user's eye level (e.g., the center of the content is aligned with the horizon). In some examples, when the first virtual content is horizon-locked 328, the first virtual content is locked in a vertical orientation relative to the horizon or direction of gravity during user interaction with the first virtual content. For example, when the first virtual content is locked in vertical orientation, the electronic device optionally maintains an alignment of the first virtual content (e.g., a user interface of the first virtual content) with the direction of gravity in the location of the user. For example, when the first virtual content is locked in vertical orientation, the electronic device optionally does not rotate the first virtual content in response to detection of a roll movement of the user's head (e.g., tilting of the user's head towards the left or right shoulder of the user); rather, electronic device 101 optionally maintains the vertical orientation of the first virtual content.

In some examples, electronic device 101 causes a resetting of (e.g., and/or a repositioning of) the eye level positioning of the first virtual content. For example, a user optionally views the first virtual content while sitting on a couch, and when the user stands (e.g., which causes the eye level of the user to be updated), electronic device 101 optionally causes the first virtual content to be changed in height relative to the ground of the environment of the user (e.g., a center of the first virtual content intersects with a horizontal line corresponding to the updated eye level and optionally continues to intersect with the updated eye level) in order to maintain the relationship of the display of the first virtual content and the eye level of the user.

As shown in FIG. 3B, content locking behavior 316 is optionally another content locking behavior 330. Another content locking behavior 330 is optionally a content locking behavior that is a combination of one or more features of content locking behaviors 320-328, or is different from the features of content locking behaviors 320-328. For example, another content locking behavior 330 is optionally body-locked 324 with elasticity, such as the elasticity described above with reference to the content locking behavior of head-locked with elasticity 322.

In some examples, the metadata of first virtual content indicates multiple content locking behaviors (e.g., two or more or all of the illustrated content locking behaviors in FIG. 3B). In some examples, the metadata indicates a priority amongst the multiple locking behaviors. For example, the metadata optionally indicates world-locked as a first priority (e.g., a first choice), head-locked as a second priority (e.g., second choice), body-locked as a third priority (e.g., third choice), etc., and the electronic device 160 optionally selects a specific metadata-indicated content locking behavior for displaying first virtual content based on the priority assigned to the specific metadata-indicated content locking behavior, and optionally additionally, based on operating conditions of the electronic device 160. Further details of the metadata indicating multiple content locking behaviors and the levels of priority thereof are described herein. In some examples, the metadata indicates an association between a given content locking behavior and a given context, and such features, and the utilization thereof, are described in more detail herein.

It is clear that the illustrated content locking behaviors of FIG. 3B are representative and nonlimiting. Further, it is clear that electronic device 101 can use respective metadata that indicates the type of content locking behavior of respective virtual content to determine a manner with which to present the respective virtual content in a three-dimensional environment. For example, electronic device 101 can use metadata indicating any of the respective content locking behaviors illustrated in FIG. 3B to determine the manner with which to present the respective virtual content corresponding to the respective content locking behavior. It should be noted that discussion herein regarding electronic device 101 using respective metadata is optionally alternatively electronic device 160 using respective metadata for determining the manner with which electronic device 101 is to present first virtual content via display 120.

In some examples, electronic device 101 overrides displaying or causing display of respective virtual content in accordance with metadata associated with the respective virtual content. In some examples, electronic device 101 overrides displaying (or overrides causing display of) respective virtual content in accordance with the content locking behavior indicated by the respective metadata associated with the respective virtual content, such that electronic device 101 displays or causes display of the respective virtual content with a content locking behavior that is different from the content locking behavior indicated by the respective metadata associated with the respective virtual content. It should be noted that discussion herein regarding electronic device 101 performing an override of displaying respective virtual content in accordance with respective metadata is optionally alternatively electronic device 160 performing the override. In some examples, the metadata indicates multiple content locking behaviors, and the electronic device 101 overrides displaying respective virtual content with a first content locking behavior indicated by the metadata and displays the respective virtual content with a second content locking behavior indicated by the metadata.

FIG. 3C illustrates a block diagram showing transitioning between presenting first virtual content in accordance with a first content locking behavior and a second content locking behavior, optionally in response to electronic device 101 determining that an override criterion is satisfied, according to some examples of the disclosure.

As shown in FIG. 3C, an electronic device can cause display of virtual content in accordance with a first content locking behavior (340), such as one of the content locking behaviors described with reference to FIG. 3B, and then, transition or override (optionally in accordance with user input) causing display of virtual content in accordance with the first content locking (arrow 342) in order to cause display of virtual content in accordance with a second content locking behavior, such as one of the content locking behaviors described with reference to FIG. 3B but different from the first content locking behavior. Similarly, as shown in FIG. 3C, an electronic device can optionally return (e.g., arrow 344) to causing display of the virtual content in accordance with the first content locking behavior. For example, as shown in FIG. 3C, an electronic device can cause display of virtual content in accordance with the second content locking behavior (346), and then transition (arrow 344), override, or return (optionally in accordance with user input or automatically without user input) to causing display of virtual content in accordance with the first content locking behavior. In some examples, the electronic device 101 transitions (e.g., causes transitioning) between the first and second content locking behaviors as defined (or indicated) by the metadata. In some examples, the electronic device 101 transitions (e.g., causes transitioning) between the first and second content locking behaviors without considering the metadata.

FIG. 3D illustrates a flowchart of a method 350 for initiating a process to display virtual content in a three-dimensional environment in accordance with a determination that an override criterion is satisfied, according to some examples of the disclosure. Method 350 is optionally performed by an electronic device (e.g., electronic device 201 of FIG. 2A or electronic device 260 of FIG. 2B).

In FIG. 3D, method 350 includes displaying (352) first virtual content with a first content locking behavior, such as a content locking behavior described with reference to FIG. 3B. For example, the first content locking behavior is optionally indicated by the metadata, such as the metadata described with reference to FIG. 3A.

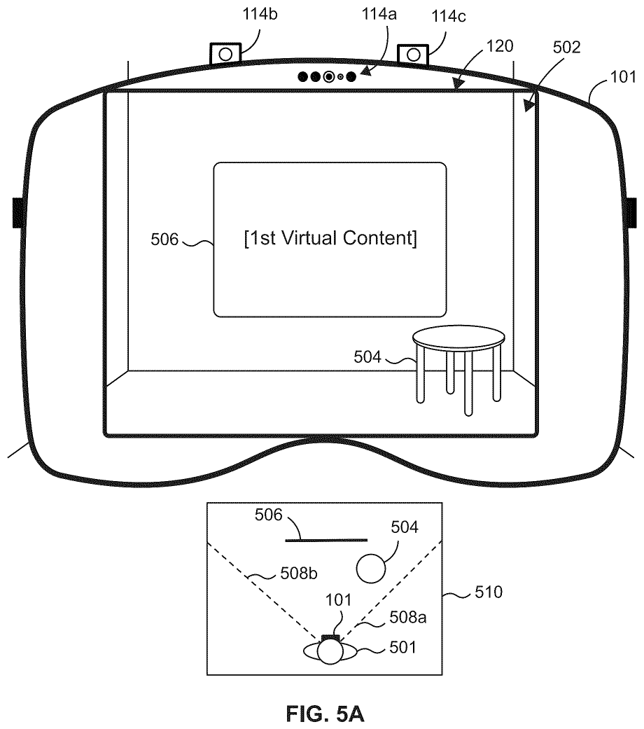

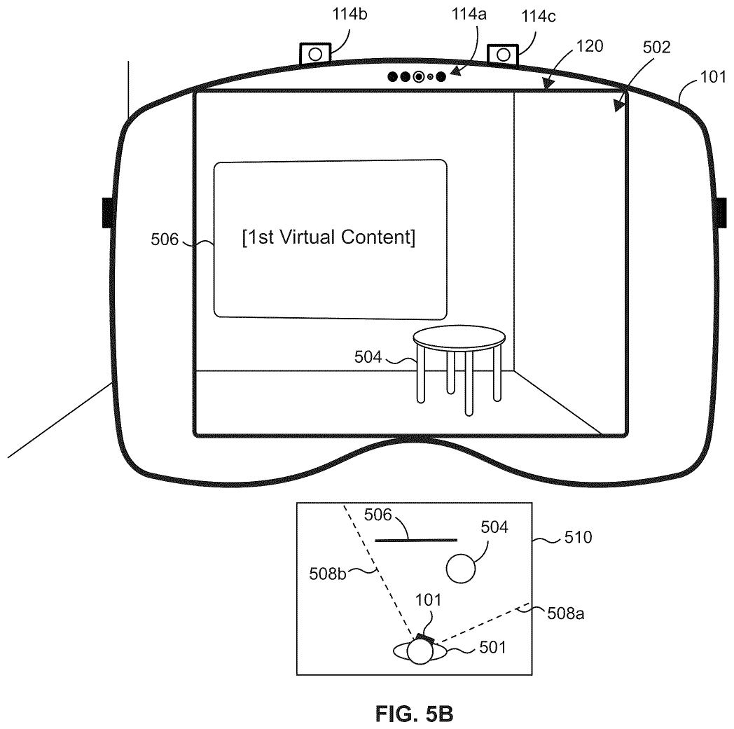

In FIG. 3D, method 350 includes determining (354) whether an override criterion is satisfied. In some examples, the override criterion is satisfied in response to receiving an override input. The override input is optionally an input corresponding to a request to override displaying the first virtual content in accordance with the content locking behavior that the metadata associated with the first virtual content indicates. The override input is optionally detected via one or more sensors in communication with electronic device 101, at electronic device 101, at electronic device 160, and/or at display 120). Override inputs are further described elsewhere herein, such as with reference to first virtual content 506 of FIGS. 5A-5B. Additionally or alternatively, method 350 includes detecting the override input. In some examples, the override criterion is satisfied as described later with reference to first virtual content 506 transitioning between content locking behaviors in FIGS. 5A-5B. In some examples, the override criterion is satisfied in response to detecting certain contexts (e.g., user is walking, user is sitting, temperature at electronic device 160 being above or below a threshold temperature, power at electronic device 160 being above or below a threshold amount of power, constrained system resources at electronic device 160, and/or other contexts).

In FIG. 3D, method 350 includes in accordance with a determination that the override criterion is not satisfied, continuing displaying (354a) the first virtual content having the first content locking behavior (e.g., without interruption).

In FIG. 3D, method 350 includes in accordance with a determination that the override criterion is satisfied, initiating (356) a process to display the first virtual content having a second content locking behavior (e.g., in accordance with an override input that corresponds to a request to override displaying the first virtual content in accordance with its associated metadata), such as a content locking behavior described with reference to FIG. 3B, different from the first content locking behavior. For example, in accordance with a determination that the override criterion is satisfied, electronic device 101 optionally causes display 120 to change the content locking behavior of the first virtual content from the first behavior, which is optionally indicated by the metadata, to the second behavior, which is optionally indicated or not indicated by the metadata, such as described with reference to transitioning between the first content locking behavior and the second content locking behavior of FIG. 3C. As such, when an override criterion is satisfied, the electronic device optionally changes the visual locking behavior of the first virtual content. In some examples, the second content locking behavior is indicated by the metadata and has a lower level of priority than the first content locking behavior. In some examples, the second content locking behavior is indicated by the metadata based on a mapping of the second content locking behavior to the specific context associated with the satisfaction of the override criterion. In some examples, the first content locking behavior is indicated by the metadata and the second content locking behavior is not indicated by the metadata. In some examples, satisfaction of a first override criterion (e.g., detection that the user is walking, user is sitting, temperature at electronic device 160 being above or below a threshold temperature, wireless connection strength at electronic device 160 being above or below a threshold cellular connection strength, power at electronic device 160 being above or below a threshold amount of power, constrained system resources at electronic device 160, and/or other contexts) results in a change of visual locking behavior to the second content locking behavior and satisfaction of a second override criterion (e.g., detection that the user is walking, user is sitting, temperature at electronic device 160 being above or below a threshold temperature, power at electronic device 160 being above or below a threshold amount of power, constrained system resources at electronic device 160, and/or other contexts), different from the first override criterion, results in a change of visual locking behavior to a third content locking behavior, different from the second content locking behavior.

It is understood that method 350 of FIG. 3D is an example and that more, fewer, or different operations can be performed in the same or in a different order. Additionally, the operations in method 350 described above are, optionally, implemented by running one or more functional modules in an information processing apparatus such as general-purpose processors (e.g., as described with respect to FIGS. 2A-2B) or application specific chips, and/or by other components of FIGS. 2A-2B.

FIGS. 4A-8C illustrate various examples of electronic devices displaying first virtual content in accordance with different content locking behaviors. These figures are intended to provide exemplary implementations of the disclosure and are not intended to be exhaustive in potential implementations of the disclosure. Thus, FIGS. 4A-8C are representative implementations and nonlimiting. Further, for case of reference, it should be noted that FIGS. 4A-8C include top-down views 410, 510, 610, 710, and 810, respectively; first virtual content 406, 506, 606, 706, 806, 807 of FIGS. 4A-8C are optionally the same or different in content; three-dimensional environments 402, 502, 602, 702, and 802 of FIGS. 4A-8C optionally include similar or different features; table 404, 504, 604, 704, and 804 of FIGS. 4A-8C optionally include similar or different features; viewing bounds 408a-408b, 508a-508b, 608a-608b, 708a-708b of FIGS. 4A-8C optionally have similar or different characteristics.

FIGS. 4A-4C illustrate first virtual content 406 that visually behaves in accordance with a content locking behavior of head-locked with elasticity (e.g., head-locked with elasticity 322 of FIG. 3B), according to some examples of the disclosure. In some examples, the content locking behavior of first virtual content 406 in FIGS. 4A-4C is a content locking behavior that metadata associated with first virtual content 406 indicates (e.g., metadata 302 of FIG. 3A but associated with first virtual content 406 of FIGS. 4A-4C). In some examples, the content locking behavior of first virtual content 406 in FIGS. 4A-4C is not the content locking behavior that the metadata associated with first virtual content 406 indicates (e.g., the content locking behavior of first virtual content 406 in FIGS. 4A-4C is determined in accordance with an override input that overrides operating the first virtual content in accordance with the content locking behavior that metadata associated with first virtual content indicates, such as described with reference to FIG. 3D).

In FIG. 4A, three-dimensional environment 402 includes first virtual content 406 and table 404, which optionally are representative of virtual object 104 and table 106 of FIG. 1, respectively. In an example, first virtual content 406 is a user interface of an application, such as a gaming application, an Internet application, or another type of application. In an example, table 404 is optionally a physical table in the physical environment. As shown in top-down view 410, electronic device 101 provides user 401 with a field of view (e.g., viewing bounds 408a-408b) in three-dimensional environment 402.

In FIG. 4A, since the content locking behavior of the first virtual content 406 is head-locked with elasticity, electronic device 101 optionally causes first virtual content 406 to behave as described with reference to head-locked with elasticity 322 of FIG. 3B. For example, as shown from FIG. 4A to FIG. 4B, in response to detecting rotation of the user's head, electronic device 101 optionally initiates movement of the first virtual content 406 in three-dimensional environment 402, such as indicated by arrow 407 in top-down view 410 in FIG. 4B. For example, from FIG. 4A to FIG. 4B, the user 401 has rotated the user's head by a first amount, as shown by the clockwise rotation of the user 401 (and thus electronic device 101) in top-down view 410 from FIG. 4A to FIG. 4B. The position of first virtual content 406 relative to the viewpoint of the user 401 (e.g., relative to display 120) in FIG. 4B is different from the position of first virtual content 406 relative to the viewpoint of the user 401 (e.g., relative to display 120) in FIG. 4A. This difference is optionally due to the spring-like behavior of the first virtual content 406 described with reference to head-locked with elasticity 322 of FIG. 3B) with which first virtual content 406 follows the head movement of the user. In response to detecting the head rotation input shown from FIG. 4A to 4B, the electronic device 101 moves the first virtual content 406 to a position relative to the viewpoint of the user (e.g., relative to display 120) in FIG. 4C that is the same as the position of first virtual content 406 relative to the viewpoint of the user in FIG. 4A (which are different positions in three-dimensional environment 402, but same positions relative to the different viewpoints of the user 401 in FIGS. 4A-4B). In some examples, when the content locking behavior of the first virtual content 406 is head-locked with elasticity (e.g., head-locked with elasticity 322 of FIG. 3B), electronic device 101 optionally initiates movement while the electronic device 101 is detecting the head rotation.

FIGS. 5A-5B illustrate first virtual content 506 having a body-locked content locking behavior and, alternatively, illustrates first virtual content 506 transitioning from a content locking behavior that is head-locked (e.g., head-locked 320 of FIG. 3B) to a content locking behavior that is body-locked (e.g., body-locked 324 of FIG. 3B), according to some examples of the disclosure.

In some examples, the content locking behavior of first virtual content 506 in FIGS. 5A-5B is the content locking behavior that metadata associated with first virtual content 506 indicates. For instance, metadata associated with first virtual content 506 optionally indicates that the content locking behavior of first virtual content 506 is body-locked. In some examples, the content locking behavior of first virtual content in FIGS. 5A-5B is not the content locking behavior that metadata associated with first virtual content 506 indicates (e.g., the content locking behavior of first virtual content in FIGS. 5A-5B is determined in accordance with an override input that overrides operating first virtual content 506 in accordance with the content locking behavior that metadata associated with first virtual content 506 indicates, such as described with reference to FIG. 3D).

In FIG. 5A, first virtual content 506 is optionally body-locked, such as described with reference to body-locked 324 of FIG. 3B. As body-locked content, electronic device 101 optionally does not reposition first virtual content 506 within three-dimensional environment 502 in response to detection of rotational movement of the user. For example, though the user 501 rotates as shown in the clockwise rotation of the user in top-down view 510, electronic device 101 optionally maintains the position of first virtual content 506 in three-dimensional environment 502 from FIG. 5A to FIG. 5B. In some examples, translational movement of the user would cause electronic device 101 to reposition first virtual content 506 in three-dimensional environment 502. In some examples, a FoV of the user is greater than or equal to a FoV for displaying all portions of first virtual content 506 at the same time, such as the FoV of the user in FIGS. 4A-4C. In some examples, a FoV of the user is less than a FoV for displaying all portions of first virtual content 506. For instance, though not shown, the length of first virtual content 406 could intersect with the viewing bound 408a-408b in top-down view 410 in FIG. 4C). When the FoV of the user is less than the FoV for displaying all portions of first virtual content 506, and the user rotates in a direction towards obscured portions of first virtual content 506 (e.g., towards non-displayed portions in the present presentation of first virtual content 506), electronic device 101 optionally causes display of the obscured portions of first virtual content 506, while maintaining the body-locked content locking behavior.

Further, FIGS. 5A-5B alternatively illustrate first virtual content 506 transitioning from a content locking behavior that is head-locked (e.g., head-locked 320 of FIG. 3B) to a content locking behavior that is body-locked (e.g., body-locked 324 of FIG. 3B), according to some examples of the disclosure. For example, the content locking behavior of first virtual content 506 of FIG. 5A is optionally head-locked (or head-locked with elasticity), such as described with reference to head-locked 320 or head-locked with elasticity 322 of FIG. 3B, instead of body-locked, and in response to electronic device 101 detecting an override input (e.g., while presenting first virtual content with the head-locked or head-locked with elasticity content locking behavior), such an override input described with reference to FIG. 3D, electronic device 101 optionally causes first virtual content 506 of FIG. 5A to be presented with a body-locked content locking behavior, such as shown and described in the behavior of first virtual content from FIG. 5A to FIG. 5B (e.g., first virtual content 506 optionally remains positioned at its location in FIGS. 5A-5B because its content locking behavior is body-locked). In some examples, the override input is the rotational movement (e.g., head rotation) of the user 501 meeting certain criteria. For example, in accordance with a determination that rotational movement of the user 501 is at or above a threshold angular speed (e.g., 5, 10, 15, 20, 25, 30 degrees per second, or another threshold angular speed), electronic device 101 optionally causes first virtual content 506 of FIG. 5A to transition from visually behaving in accordance with a head-locked content locking behavior (e.g., head-locked 320 or head-locked with elasticity 322 of FIG. 3B) to visually behaving in accordance with a body-locked content locking behavior (e.g., body-locked 324 of FIG. 3B), and in accordance with a determination that rotational movement of the user 501 is below a threshold angular speed, electronic device optionally forgoes causing first virtual content 506 of FIG. 5A to transition from visually behaving in accordance with the head-locked content locking behavior to visually behaving in accordance with the body-locked content locking behavior, and continues displaying first virtual content 506 as visually behaving in accordance with the head-locked content locking behavior. In some examples, a content locking behavior of first virtual content is automatically chosen based on safety, such as electronic device 101 transitioning content locking behavior of first virtual content in accordance with the determination that rotation of user 501 is at or above the threshold angular speed discussed above.

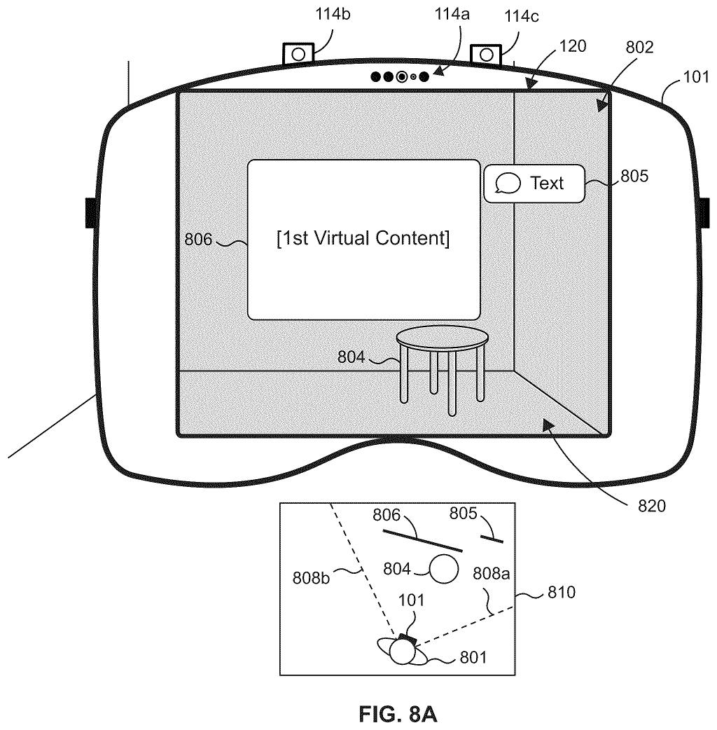

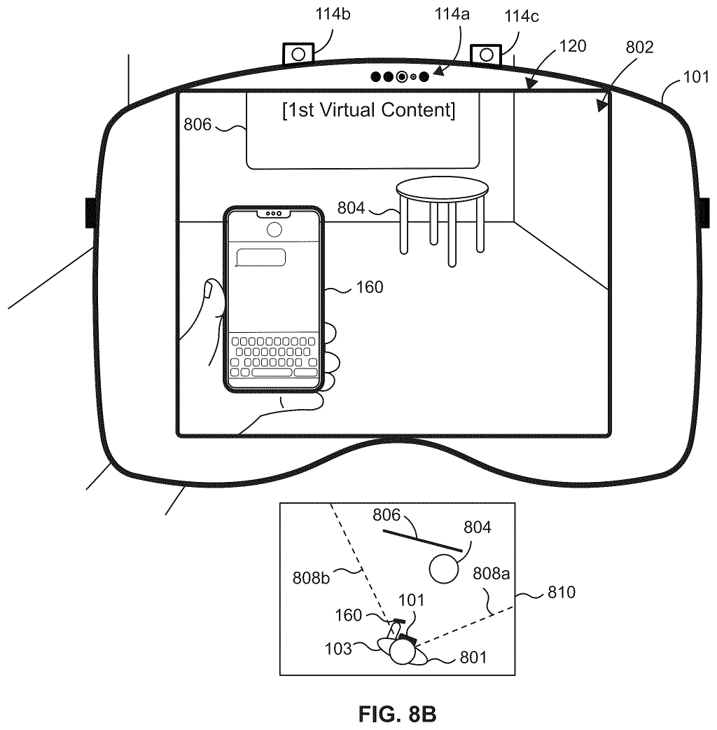

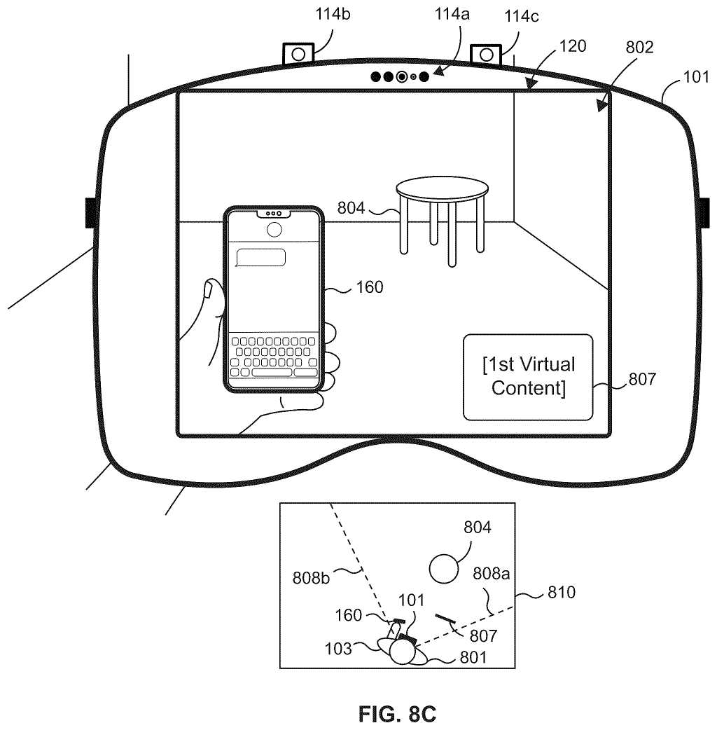

In some examples, from FIG. 5A to FIG. 5B, first virtual content 506 transitions from a head-locked content locking behavior to a body lock content locking behavior in response to detection of a request to enter text into a keyboard (e.g., a keyboard of a phone or computer, such as electronic device 160), a request corresponding to user access of a phone, and/or head-motion. For example, first virtual content 506 optionally has a head-locked with elasticity content locking behavior, and in response to detection of a request to enter text into a keyboard (e.g., a keyboard of a phone or computer), such as described below with reference to FIGS. 8A-8B, a request corresponding to user access of a phone, such as described below with reference to FIGS. 8A-8B, and/or head-motion, such as the head rotation of the user described above with reference to FIGS. 5A-5B. For example, first virtual content 506 is optionally a user interface of an Internet application, such as a web browser application, for which metadata indicates a preferred content locking behavior of head-locked (or head-locked with elasticity) content locking behavior, and in response to detection of user request to enter text into the web browser application (or in response to detection that a text entry region is displayed on the web browser application), electronic device 101 optionally transitions the content locking behavior of first virtual content 506 from the head-locked content (or head-locked with elasticity) content locking behavior to the body-locked content locking behavior, optionally so that the user can type in text into the web browser application via the user's phone (e.g., electronic device 160). In some examples, in response to detection of user request to search the user's query entered into the text entry of the web browser (e.g., user hitting the “Enter” key, or another key corresponding a request to initiate searching of the user's query), electronic device 101 optionally transitions back the content locking behavior of first virtual content 506 to head-locked or head-locked with elasticity. In some examples, the electronic device 101 transitions (e.g., causes transitioning) between the first and second content locking behaviors as defined (or indicated) by the metadata. In some examples, the electronic device 101 transitions (e.g., causes transitioning) between the first and second content locking behaviors without considering the metadata. Thus, as described and illustrated previously with reference to FIG. 3D, electronic device 101 can cause virtual content to transition from a first content locking behavior to a second content locking behavior, and then, cause virtual content to transition back to the first content locking behavior. As such, in some examples, while electronic device 101 is presenting first virtual content 506 having a head-locked content locking behavior, when a user initiates a process that involves user input at electronic device 160 (e.g., touch on soft keyboard, touch on user interface element displayed via electronic device 160, voice input or another type of user input), electronic device 101 optionally presents first virtual content 506 having a body-locked content locking behavior during the receiving of the user input at electronic device 160. In some examples, electronic device 101 transitions the content locking behavior of the first virtual content from the head-locked content locking behavior to the body-locked content locking behavior based on the metadata. For instance, the metadata optionally includes one or more indications that the first virtual content is to transition content locking behavior from the head-locked content locking behavior to the body-locked content locking behavior in response to detection of a request to type into a keyboard. In some examples, electronic device 101 transitions the content locking behavior of the first virtual content from the head-locked content locking behavior to the body-locked content locking behavior in response to detection of a request to type into a keyboard, even when the metadata optionally does not include an indication that the first virtual content is to transition content locking behavior from the head-locked content locking behavior to the body-locked content locking behavior in response to detection of a request to type into a keyboard.

FIGS. 6A-6B illustrate a resetting of a placement and/or orientation of first virtual content 606, according to some examples of the disclosure. In FIG. 6A, first virtual content 606 optionally visually behaves in accordance with a body-locked content locking behavior (e.g., body-locked 324 of FIG. 3B). The position of first virtual content 606 in three-dimensional environment 602 in FIG. 6A is optionally the same as the position of first virtual content 506 in three-dimensional environment 502 in FIG. 5B. As shown in FIG. 6A, the position of first virtual content 606 in three-dimensional environment 602 is off center from a center location of the viewpoint of the user 601. User 601 of FIG. 6A may desire to reset the placement of first virtual content 606. For example, user 601 optionally desires to place first virtual content 606 at a central location relative to the viewpoint of the user 601 in FIG. 6A.

Present examples provide for resetting or repositioning first virtual content 606 in three-dimensional environment 602. For example, electronic device 101 optionally initiates resetting or repositioning of first virtual content 606 in response to user input or without user input. In some examples, electronic device 160 is optionally in communication with electronic device 101 and/or display 120. User input requesting to reset the position of first virtual content 606 is optionally received at electronic device 101 or at electronic device 160 (e.g., a mobile phone, a stylus, a watch), and in response to detecting that the user input requesting to reset the position of first virtual content is received, the position of first virtual content 606 is reset. For example, in response to detecting that the user input requesting to reset the position of first virtual content is received, electronic device 101 optionally ceases displaying first virtual content 606 at the off centered position shown in FIG. 6A (e.g., ceases displaying a center of first virtual content 606 at the off center position relative to the viewpoint of the user 601 shown in FIG. 6A) and displays first virtual content 606 at the center position in three-dimensional environment 602 relative to the viewpoint of the user 601, as shown in FIG. 6B. In some examples, in response to detecting that the user input requesting to reset the position of first virtual content is received, electronic device 101 visually moves first virtual content to the center position in three-dimensional environment 602 relative to the viewpoint of the user 601, such as moving the first virtual content to the center position within an amount of time that is proportional to an amount of displacement between the position of the first virtual content when the reset input is received and the position of the center position (e.g., the greater the amount of displacement, the greater the amount of time taken to move the first virtual content to the center position).

In some examples, the user input requesting to reset the position of first virtual content, such as shown from FIG. 6A to FIG. 6B, is received at electronic device 160 or electronic device 101. In some examples, the user input is detected via a virtual or physical selection of a virtual or physical button on electronic device 160, or via a button (e.g., physical or virtual) on electronic device 101, optionally from hand 103 of the user directed at the button. In some examples, input requesting to reset the position of first virtual content is detected via sensors (e.g., via sensors of electronic device 160 or electronic device 101, such as via orientation sensor(s) 210A, 210B of FIGS. 2A-2B). For example, a user is optionally a passenger of a moving vehicle, such as a moving bus, and electronic device 101 resets the position or orientation of first virtual content 606, in a manner so as to maintain body-locked functionalities of first virtual content 606 even during turns that the moving vehicle might make. In some examples, electronic device 101 automatically resets position of first virtual content (e.g., without user input), such as when first virtual content 606 is off center in display 120 for a predetermined period of time (e.g., 30 s, 35 s, 45 s, 1 min, 2 min, 5 min, or another predetermined period of time) and/or when an angle between the viewpoint of the electronic device and the first virtual content 606 is greater than a threshold viewing angle (e.g., more than 30, 35, 45, 50 percent, or another threshold viewing angle corresponding to the angle given by a difference between a normal of the first virtual content 606 and a direction of the viewpoint of the user). For example, the electronic device 160 optionally initiates the resetting in response to detection that the angle is greater than a threshold viewing angle. In some examples, the resetting of the position of first virtual content, such as shown from FIG. 6A to FIG. 6B, includes reducing in visual prominence (e.g., fading out, reducing in brightness, and/or dimming) the first virtual content at its position in FIG. 6A, and increasing in visual prominence (e.g., fading in, increasing in brightness, initiating display) the first virtual content at its position FIG. 6B.

FIGS. 7A-7D illustrate a content locking behavior of first virtual content 706 that is head-locked (e.g., head-locked 320 of FIG. 3B), according to some examples of the disclosure. From FIG. 7A to FIG. 7B, the head of the user 701 (and thus electronic device 101 and display 120) rotates clockwise (e.g., without the torso of the user rotating) from the perspective of top-down view 710, and in response, electronic device 101 maintains the placement of the first virtual content 706 on display 120. From FIG. 7B to FIG. 7C, the head of the user 701 (and thus electronic device 101 and display 120) further rotates clockwise (e.g., without the torso of the user rotating) from the perspective of top-down view 710, and in response, electronic device 101 maintains the placement of the first virtual content 706 on display 120 at the same location on display 120 as in FIGS. 7A and 7B. From FIG. 7C to FIG. 7D, the torso of the user 701 rotates clockwise without the head of the user 701 rotating (e.g., without electronic device 101 and display 120 rotating), and in response, electronic device maintains the location of the first virtual content 706 in the same location relative to the physical environment of the user that the first virtual content 706 had in FIG. 7C. As such, when head-locked, first virtual content 706 is locked to display 120, such that first virtual content 706 continues to occupy the same display area (e.g., the same number of display pixels) and/or position on display 120 even when electronic device 101 and/or display 120 are moved (e.g., rotated).

FIGS. 8A-8C illustrate electronic device 101 transitioning content locking behaviors of first virtual content 806 in accordance with satisfaction of an override criterion, according to some examples of the disclosure.

In FIG. 8A, the content locking behavior of first virtual content 806 (e.g., a user interface of a movie application or a gaming application, or of another type of application) is optionally body-locked (e.g., body-locked 324 of FIG. 3B). In FIG. 8A, first virtual content 806 is concurrently presented with a tint 820 (e.g., a virtual lighting and/or coloring effect) applied to portions of display 120 that are outside of presentation of first virtual content 806 optionally in order to de-emphasize portions of display 120 that are outside of visual presentation of first virtual content 806 and emphasize portions of display 120 that are inside of visual presentation of first virtual content 806, so as to increase user immersion in first virtual content 806. While displaying first virtual content 806 as body-locked content, electronic device 101 optionally detects that a notification event (e.g., a text message) has been received at electronic device 101. In response, electronic device 101 optionally causes display, via display 120, of a notification 805 concurrent with display of the first virtual content 806 as body-locked content, such as shown in FIG. 8A. Notification 805 optionally visually notifies user 801 that a text message has been received at electronic device 160.

In some examples, electronic device 101 detects that an override criterion is satisfied, such as an override criterion that is satisfied when user 801 seeks to interact with electronic device 160 (e.g., electronic device 101 detects movement (e.g., rotation) of electronic device 101 that is in the direction of electronic device 160 and/or electronic device 101 detects that a relative distance between electronic device 101 and electronic device 160 changes (e.g., is smaller than before notification 805 was displayed)). In some examples, the detection mentioned above is made at electronic device 160 and the detection is communicated to electronic device 101; alternatively, in some examples, the detection mentioned above is made at electronic device 101 and the detection is communicated to electronic device 160. In some examples, when user 801 initiates interaction with electronic device 160 (e.g., user 801 turns/rotates user's head towards electronic device 160, which causes electronic device 101 to be oriented towards electronic device 160), electronic device 101 maintains presentation of first virtual content 806 at the same location in three-dimensional environment 802 as in FIG. 8A and with the same body-locked content locking behavior, such as illustrated from FIG. 8A to FIG. 8B. In FIG. 8B, electronic device 101 removes the tint 820 associated with presentation of first virtual content 806 while optionally maintaining presentation (e.g., playback or simply visual presentation in a paused state of playback, if, for example, first virtual content 806 includes media playback) of first virtual content 806 at the same position in three-dimensional environment 802 that first virtual content 806 had when the notification 805 was displayed.

In some examples, when user 801 initiates interaction with electronic device 160 (e.g., user 801 turns user's head towards electronic device 160, which causes electronic device 101 to be oriented toward the electronic device 160), electronic device 101 (and/or electronic device 160) causes the content locking behavior of first virtual content 806 to transition from body-locked (e.g., body-locked 324 of FIG. 3B) to head-locked (e.g., head-locked 320 of FIG. 3B), such as shown from FIG. 8A to FIG. 8C. In some examples, when user 801 initiates interaction with electronic device 160 (e.g., user 801 turns user's head towards electronic device 160), electronic device 101 (and/or electronic device 160) causes the content locking behavior of first virtual content 806 to transition from body-locked to head-locked and optionally causes first virtual content 806 to be displayed at a predetermined position relative to the viewpoint of the user 801 and/or a predetermined position on the display 120, such as shown from FIG. 8A to FIG. 8C. For example, when user 801 initiates interaction with electronic device 160 (e.g., user 801 turns user's head towards electronic device 160), electronic device 101 (and/or electronic device 160) optionally causes first virtual content 806 to reduce in display size and to be displayed at a lower, right position (e.g., at a corner) of display 120 in order to provide presentation space for the user 801 to see the text message (e.g., corresponding to notification 805) on electronic device 160 via (e.g., through) display 120 and to optionally respond to the text message. Alternatively, in some examples, when user 801 initiates interaction with electronic device 160 (e.g., user 801 turns user's head towards electronic device 160), electronic device 101 (and/or electronic device 160) optionally causes first virtual content 806 to cease being displayed via display 120, and electronic device 160 displays first virtual content 806 (e.g., in two dimensions) via display generation component(s) of electronic device 160 (e.g., via display generation component(s) 214B of electronic device 260 of FIG. 2B), optionally in a reduced display size on the display generation component(s) of electronic device 160 in order to provide presentation space for the user 801 to see the text message on electronic device 160 via (e.g., through) display generation component 120 and to optionally respond to the text message. In some examples, electronic device 101 returns to presenting first virtual content 806 in the configuration illustrated in FIG. 8A after user 801 completes the user's interaction with electronic device 160. For example, while user 801 is interacting with electronic device 160, such as illustrated and described with reference to FIGS. 8B and 8C, user 801 optionally indicates via electronic device 160 or via input detected via an input device in communication with electronic device 160, or via input detected via sensors of electronic device 101 (e.g., movement of electronic device 101 to no longer be oriented in the direction of the electronic device 160), that user 801 has completed the user's interaction with electronic device 160. In response, electronic device 101 optionally returns to presenting first virtual content 806 in the configuration illustrated in FIG. 8A, including presenting first virtual content 806 and the tint 820 outside of the first virtual content 806 that increases user immersion in first virtual content 806.

Any transition of content locking behavior described herein as being performed or initiated by electronic device 101 could similarly or alternatively be performed or initiated by electronic device 160. Also, electronic device 160 optionally performs some, most, or all processing involved with presenting (e.g., displaying), via display 120 of electronic device 101, first virtual content in accordance with any of the described content locking behaviors. As such, in some examples, electronic device 160 determines the behavior of first virtual content that is displayed via display 120 of electronic device 101, optionally independent of whether said behavior is in accordance with the metadata associated with first virtual content.

In some examples, electronic device 101 presents first virtual content concurrently with a user interface element associated with first virtual content. For instance, electronic device 101 optionally presents first virtual content including a movie concurrently with captions that corresponds to the movie. In this example, electronic device 101 optionally presents first virtual content including the movie with a body-locked content locking behavior while presenting the captions that corresponds to the movie with a head-locked content locking behavior.

In some examples, electronic device 101 presents first virtual content and second virtual content. In some examples, first virtual content includes a first user interface of a first application, and second virtual content includes a second user interface of a second application (e.g., any application different from the first application). In some examples, electronic device 101 concurrently presents first virtual content and second virtual content via display 120 in a row or other relative orientation having the same content locking behavior or having different content locking behaviors.

In some examples, a content locking behavior which with first virtual content can be displayed is limited by a developer associated with the first virtual content and/or by device constraints. For example, metadata associated with the first virtual content optionally restricts display of first virtual content to being displayed only in accordance with the preferred content locking behavior that is indicated by the metadata.

In some examples, while or when electronic device 101 initiates (e.g., is about to) present first virtual content with a content locking behavior that is different from a content locking behavior that is indicated by metadata associated with first virtual content, electronic device 101 optionally presents a notification (e.g., a visual notification, such as a text label including “head-locked,” “body-locked,” etc.) indicating the preferred content locking behavior that is indicated by the metadata associated with the first virtual content.

In some examples, the metadata of first virtual content indicates multiple content locking behaviors (e.g., two or more or all of the illustrated content locking behaviors in FIG. 3B). In some examples, the metadata indicates a priority amongst the multiple locking behaviors. For example, the metadata optionally indicates world-locked as a first priority (e.g., a first choice), head-locked as a second priority (e.g., second choice), body-locked as a third priority (e.g., third choice), etc. In some examples, when the electronic device is restricted from choosing a particular content locking behavior or chooses not to use a particular content locking behavior (e.g., due to electronic device limitations, amount of power, amount of available computing resources available to be dedicated to a particular content locking behavior, etc.), the electronic device considers the metadata to determine which content locking behavior to display the first virtual content in view of the operating conditions of the electronic device 160. Thus, in some examples, electronic device 160 considers the metadata to determine which content locking behavior to display the first virtual content in view of operating conditions of the electronic device 160. In some examples, a content locking behavior which with first virtual content can be displayed via display 120 of electronic device 101 is determined by operating parameters of electronic device 160 and/or the priority data indicated by the metadata. For example, some content locking behaviors involve higher orders of processing (e.g., more processing at electronic device 160), and in accordance with a determination that electronic device 160 is operating at, near, or above a first thermal condition when it is requested to cause display of first virtual content with a content locking behavior that involves higher orders of processing, electronic device 160 optionally forgoes causing display of first virtual content with the content locking behavior that involves higher orders of processing (e.g., body-locked content locking behavior is optionally resource intensive), and causes display of first virtual content with a content locking behavior that involves lower orders of processing. Continuing with this example, and in accordance with a determination that electronic device 160 is operating at, near, or above, a first thermal condition when it is requested to cause display of first virtual content with a content locking behavior that involves higher orders of processing, electronic device 160 optionally forgoes causing display of first virtual content with the content locking behavior that involves higher orders of processing, and causes display of first virtual content with a content locking behavior that involves lower orders of processing at electronic device 160 (e.g., head-locked or display-locked is optionally less resource intensive than body-locked content locking behavior). Similar operations discussed with reference to the determination that electronic device 160 is operating at, near, or above the first thermal condition can be performed when electronic device 160 is operating in a lower power operating state, such as in a low power mode.

In some examples, the metadata indicates an association between a given content locking behavior and a desired context, and the electronic device optionally determines a metadata-indicated content locking behavior based on the desired context. For example, if the metadata indicates that if the user is walking (e.g., the movement of the electronic device 101 is below a threshold amount of movement (e.g., in terms of velocity)), display the first virtual content as body-locked, then the electronic device 101 optionally displays the first virtual content as body-locked in response to detecting that the user is walking. As another example, if the metadata indicates that if the user is at home and sitting (e.g., the electronic device 101 is located at a location corresponding to a home location and/or the electronic device 101 is not in motion), display the first virtual content as world-locked, then the electronic device 101 optionally displays the first virtual content as world-locked in response to detecting that the user is at home and sitting. Other mapping of contexts and content locking behaviors are contemplated. Thus, the metadata optionally indicates a mapping of specific contexts to specific content locking behaviors (e.g., the metadata indicates different content locking behaviors for different contexts).

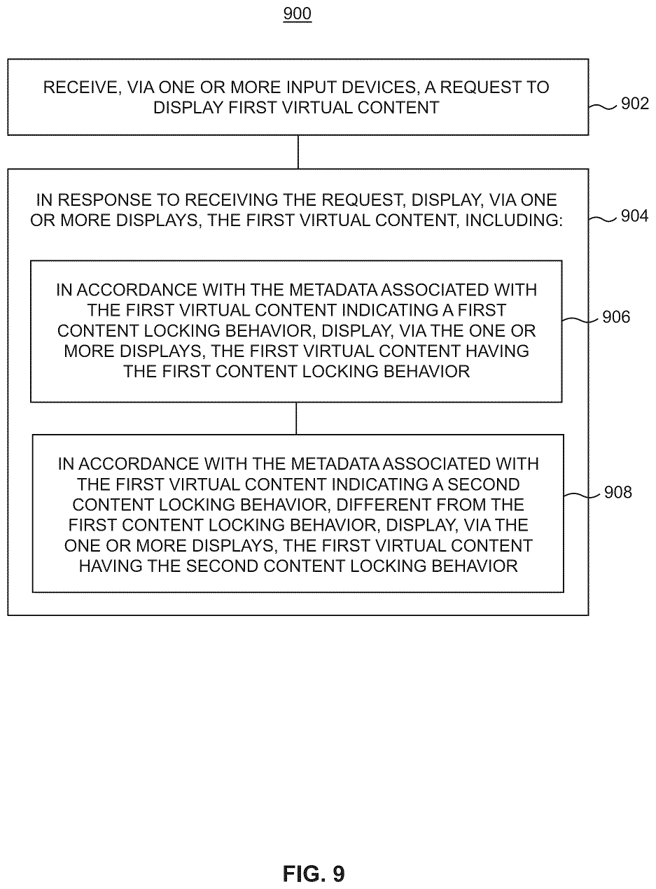

Therefore, according to the above, some examples of the disclosure are directed to a method (e.g., method 900 of FIG. 9) performed at a computing system (e.g., at electronic device 101 and/or electronic device 160) in communication with one or more input devices and one or more displays. The method includes receiving (902), via the one or more input devices, a request to display first virtual content; in response to receiving the request, displaying (904), via the one or more displays, the first virtual content, including: in accordance with metadata associated with the first virtual content indicating a first content locking behavior, displaying (906), via the one or more displays, the first virtual content having the first content locking behavior; and in accordance with the metadata associated with the first virtual content indicating a second content locking behavior, different from the first content locking behavior, displaying (908), via the one or more displays, the first virtual content having the second content locking behavior.

Additionally or alternatively, the first content locking behavior is one of head-locked, head-locked with elasticity, body-locked, display-locked, horizon-locked, world-locked, or tilt locked, and the second content locking behavior is one of head-locked, head-locked with elasticity, body-locked, display-locked, horizon-locked, world-locked, or tilt locked, different from the first content locking behavior, or another content locking behavior different from the first content locking behavior.

Additionally or alternatively, the metadata associated with the first virtual content indicates a first context for displaying the first virtual content having the first content locking behavior and a second context, different from the first context, for displaying the first virtual content having the second content locking behavior. Displaying the first virtual content having the first content locking behavior is further in accordance with a determination that the computing system is operating in the first context and displaying the first virtual content having the second content locking behavior is further in accordance with a determination that the computing system is operating in the second context.

Additionally or alternatively, the metadata associated with the first virtual content indicates at least the first content locking behavior and the second content locking behavior, a first level of priority for displaying the first virtual content with the first content locking behavior, and a second level of priority, different from the first level of priority, for displaying the first virtual content with the second content locking behavior.

Additionally or alternatively, the method includes while displaying the first virtual content having the first content locking behavior in accordance with the metadata indicating the first content locking behavior or having the second content locking behavior in accordance with the metadata indicating the second content locking behavior: detecting that an override criterion is satisfied; and in response to detecting that the override criterion is satisfied, displaying, via the one or more displays, the first virtual content having a third content locking behavior that is different from the content locking behavior of the first virtual content when satisfaction of the override criterion is detected, such as described with reference to FIGS. 3C and 3D. Additionally or alternatively, while the first virtual content is displayed having the first content locking behavior or the second content locking behavior that is in accordance with the metadata in response to receiving the request, a user of the computing system is associated with a first head orientation or a first body orientation; and the override criterion is satisfied when user input including head rotation or body rotation relative to the first head orientation or the first body orientation, respectively, is detected. Additionally or alternatively, in accordance with a determination that the metadata indicates the first content locking behavior and the first virtual content has the first content locking behavior in response to receiving the request, the third locking behavior is the second content locking behavior; and in accordance with a determination that the metadata indicates the second content locking behavior and the first virtual content has the second content locking behavior in response to receiving the request, the third locking behavior is the first content locking behavior. Additionally or alternatively, the third content locking behavior is different from the first content locking behavior and the second content locking behavior. Additionally or alternatively, displaying the first virtual content having the third content locking behavior in response to detecting that the override criterion is satisfied is further in accordance with a determination that the metadata indicates that the first virtual content is to have the third content locking behavior in response to detecting that the override criterion is satisfied, or displaying the first virtual content having the third content locking behavior in response to detecting that the override criterion is satisfied is independent of whether the determination that the metadata indicates that the first virtual content is to have the third content locking behavior in response to detecting that the override criterion is satisfied is made.

Additionally or alternatively, the first content locking behavior is body-locked, and in response to receiving the request, the first virtual content has the first content locking behavior and is displayed at a first location corresponding to a first respective location in a physical environment. Additionally or alternatively, the method includes detecting, via the one or more input devices, an event corresponding to a change in viewpoint of the computing system; and in response to detecting the event: in accordance with a determination that the change in viewpoint of the computing system corresponds to a change in the viewpoint from a first viewpoint to a second viewpoint that is within a set of viewpoints for viewing the first virtual content at the first location corresponding to the first respective location in the physical environment, continuing displaying, via the one or more displays, the first virtual content having the first content locking behavior at the first location corresponding to the first respective location in the physical environment. Additionally or alternatively, the method includes detecting, via the one or more input devices, an event corresponding to a change in viewpoint of the computing system; and in response to detecting the event, and in accordance with a determination that the change in viewpoint corresponds to a change in the viewpoint from the first viewpoint to a third viewpoint, different from the second viewpoint, that is outside of the set of viewpoints for viewing the first virtual content at the first location corresponding to the first respective location in the physical environment: ceasing display of the first virtual content having the first content locking behavior at the first location corresponding to the first respective location in the physical environment; and displaying, via the one or more displays, the first virtual content having the first content locking behavior at a second location corresponding to a second respective location in a physical environment, wherein the second respective location in the physical environment is different from the first respective location in the physical environment. For example, as described above with reference to first virtual content 606 of FIGS. 6A-6B, a user is optionally a passenger of a moving vehicle, such as a moving bus, and the event corresponding to the change in viewpoint of the computing system optionally includes turn of the vehicle while the first virtual content is body-locked. In this example, when the angle between the viewpoint of the computing system and the first virtual content 606 is greater than a threshold viewing angle (e.g., more than 30, 35, 45, 50 percent, or another threshold viewing angle corresponding to the angle given by difference between a normal of the first virtual content 606 and a direction of the viewpoint of the user) for viewing first virtual content 606 as body-locked, electronic device 101 optionally resets the position or orientation of first virtual content 606 in three-dimensional environment to make the angle between the viewpoint of the computing system and the first virtual content 606 to be less than the threshold viewing angle, in a manner so as to maintain the same body-locked functionalities of first virtual content 606 that first virtual content 606 had before the vehicle turned. Additionally or alternatively, the method includes in accordance with a determination that the change in viewpoint is from the first viewpoint to the third viewpoint: fading out (e.g., reducing in visual prominence, reducing in brightness, and/or dimming) the first virtual content having the first content locking behavior at the first location corresponding to the first respective location in the physical environment; and fading in (e.g., initiating display, increasing a visual prominence, and/or increasing in brightness) the first virtual content having the first content locking behavior at the second location corresponding to the second respective location in the physical environment.

Additionally or alternatively, the method includes in accordance with a determination that the change in viewpoint is from the first viewpoint to the third viewpoint, visually moving the first virtual content having the first content locking behavior from the first location corresponding to the first respective location in the physical environment to the second location corresponding to the second respective location in the physical environment.

Additionally or alternatively, the one or more displays includes a head-mounted display.

Additionally or alternatively, the first virtual content includes a game user interface.

Additionally or alternatively, the first virtual content includes a movie (e.g., a user interface of a media playback application that includes a movie in playback).

Additionally or alternatively, the first virtual content includes a web browser.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method comprising:
at a computing system in communication with one or more input devices and one or more displays:
receiving, via the one or more input devices, a request to display first virtual content; and
in response to receiving the request, displaying, via the one or more displays, the first virtual content, including:
in accordance with metadata associated with the first virtual content indicating a first content locking behavior, displaying, via the one or more displays, the first virtual content having the first content locking behavior; and
in accordance with the metadata associated with the first virtual content indicating a second content locking behavior, different from the first content locking behavior, displaying, via the one or more displays, the first virtual content having the second content locking behavior.

2. The method of claim 1, wherein:
the first content locking behavior is one of head-locked, head-locked with elasticity, body-locked, display-locked, horizon-locked, world-locked, or tilt locked; and
the second content locking behavior is one of head-locked, head-locked with elasticity, body-locked, display-locked, horizon-locked, world-locked, or tilt-locked, different from the first content locking behavior, or another content locking behavior different from the first content locking behavior.

3. The method of claim 1, wherein:
the metadata associated with the first virtual content indicates:
a first context for displaying the first virtual content having the first content locking behavior; and
a second context, different from the first context, for displaying the first virtual content having the second content locking behavior;
displaying the first virtual content having the first content locking behavior is further in accordance with a determination that the computing system is operating in the first context; and
displaying the first virtual content having the second content locking behavior is further in accordance with a determination that the computing system is operating in the second context.

4. The method of claim 1, comprising:
while displaying the first virtual content having the first content locking behavior in accordance with the metadata indicating the first content locking behavior or having the second content locking behavior in accordance with the metadata indicating the second content locking behavior:
detecting that an override criterion is satisfied; and
in response to detecting that the override criterion is satisfied, displaying, via the one or more displays, the first virtual content having a third content locking behavior that is different from the content locking behavior of the first virtual content when satisfaction of the override criterion is detected.

5. The method of claim 4, wherein:
while the first virtual content is displayed having the first content locking behavior or the second content locking behavior that is in accordance with the metadata in response to receiving the request, a user of the computing system is associated with a first head orientation or a first body orientation; and
the override criterion is satisfied when user input including head rotation or body rotation relative to the first head orientation or the first body orientation, respectively, is detected.

6. The method of claim 4, wherein:
in accordance with a determination that the metadata indicates the first content locking behavior and the first virtual content has the first content locking behavior in response to receiving the request, the third content locking behavior is the second content locking behavior; and
in accordance with a determination that the metadata indicates the second content locking behavior and the first virtual content has the second content locking behavior in response to receiving the request, the third content locking behavior is the first content locking behavior.

7. The method of claim 4, wherein the third content locking behavior is different from the first content locking behavior and the second content locking behavior.

8. The method of claim 7, wherein:
displaying the first virtual content having the third content locking behavior in response to detecting that the override criterion is satisfied is further in accordance with a determination that the metadata indicates that the first virtual content is to have the third content locking behavior in response to detecting that the override criterion is satisfied; or
displaying the first virtual content having the third content locking behavior in response to detecting that the override criterion is satisfied is independent of whether the determination that the metadata indicates that the first virtual content is to have the third content locking behavior in response to detecting that the override criterion is satisfied is made.

9. An electronic device comprising:
one or more processors;
memory; and
one or more programs stored in the memory and configured to be executed by the one or more processors of the electronic device, wherein the electronic device is in communication with one or more input devices and one or more displays, and wherein the one or more programs include instructions for performing a method comprising:
receiving, via the one or more input devices, a request to display first virtual content; and
in response to receiving the request, displaying, via the one or more displays, the first virtual content, including:
in accordance with metadata associated with the first virtual content indicating a first content locking behavior, displaying, via the one or more displays, the first virtual content having the first content locking behavior; and
in accordance with the metadata associated with the first virtual content indicating a second content locking behavior, different from the first content locking behavior, displaying, via the one or more displays, the first virtual content having the second content locking behavior.

10. The electronic device of claim 9, wherein the first content locking behavior is body-locked, wherein in response to receiving the request, the first virtual content has the first content locking behavior and is displayed at a first location corresponding to a first respective location in a physical environment, and wherein the method comprises:
detecting, via the one or more input devices, an event corresponding to a change in viewpoint of the electronic device; and
in response to detecting the event:
in accordance with a determination that the change in viewpoint of the electronic device corresponds to a change in the viewpoint from a first viewpoint to a second viewpoint that is within a set of viewpoints for viewing the first virtual content at the first location corresponding to the first respective location in the physical environment, continue displaying, via the one or more displays, the first virtual content having the first content locking behavior at the first location corresponding to the first respective location in the physical environment; and
in accordance with a determination that the change in viewpoint corresponds to a change in the viewpoint from the first viewpoint to a third viewpoint, different from the second viewpoint, that is outside of the set of viewpoints for viewing the first virtual content at the first location corresponding to the first respective location in the physical environment:
ceasing display of the first virtual content having the first content locking behavior at the first location corresponding to the first respective location in the physical environment; and
displaying, via the one or more displays, the first virtual content having the first content locking behavior at a second location corresponding to a second respective location in a physical environment, wherein the second respective location in the physical environment is different from the first respective location in the physical environment.

11. The electronic device of claim 10, wherein the method comprises:
in accordance with a determination that the change in viewpoint is from the first viewpoint to the third viewpoint:
fading out the first virtual content having the first content locking behavior at the first location corresponding to the first respective location in the physical environment; and
fading in the first virtual content having the first content locking behavior at the second location corresponding to the second respective location in the physical environment.

12. The electronic device of claim 10, wherein the method comprises:
in accordance with a determination that the change in viewpoint is from the first viewpoint to the third viewpoint:
visually moving the first virtual content having the first content locking behavior from the first location corresponding to the first respective location in the physical environment to the second location corresponding to the second respective location in the physical environment.

13. The electronic device of claim 9, wherein:
the first content locking behavior is one of head-locked, head-locked with elasticity, body-locked, display-locked, horizon-locked, world-locked, or tilt locked; and
the second content locking behavior is one of head-locked, head-locked with elasticity, body-locked, display-locked, horizon-locked, world-locked, or tilt-locked, different from the first content locking behavior, or another content locking behavior different from the first content locking behavior.

14. The electronic device of claim 9, wherein:
the metadata associated with the first virtual content indicates:
a first context for displaying the first virtual content having the first content locking behavior; and
a second context, different from the first context, for displaying the first virtual content having the second content locking behavior;
displaying the first virtual content having the first content locking behavior is further in accordance with a determination that the electronic device is operating in the first context; and
displaying the first virtual content having the second content locking behavior is further in accordance with a determination that the electronic device is operating in the second context.

15. The electronic device of claim 9, wherein:
the metadata associated with the first virtual content indicates:
at least the first content locking behavior and the second content locking behavior;
a first level of priority for displaying the first virtual content with the first content locking behavior; and
a second level of priority, different from the first level of priority, for displaying the first virtual content with the second content locking behavior.

16. The electronic device of claim 9, wherein the one or more displays includes a head-mounted display.

17. A non-transitory computer readable storage medium storing one or more programs, the one or more programs comprising instructions, which when executed by one or more processors of an electronic device that is in communication with one or more input devices and one or more displays, cause the electronic device to perform a method comprising:
receiving, via the one or more input devices, a request to display first virtual content; and
in response to receiving the request, displaying, via the one or more displays, the first virtual content, including:
in accordance with metadata associated with the first virtual content indicating a first content locking behavior, displaying, via the one or more displays, the first virtual content having the first content locking behavior; and
in accordance with the metadata associated with the first virtual content indicating a second content locking behavior, different from the first content locking behavior, displaying, via the one or more displays, the first virtual content having the second content locking behavior.

18. The non-transitory computer readable storage medium of claim 17, wherein:
the first content locking behavior is one of head-locked, head-locked with elasticity, body-locked, display-locked, horizon-locked, world-locked, or tilt locked; and
the second content locking behavior is one of head-locked, head-locked with elasticity, body-locked, display-locked, horizon-locked, world-locked, or tilt-locked, different from the first content locking behavior, or another content locking behavior different from the first content locking behavior.

19. The non-transitory computer readable storage medium of claim 17, wherein:
the metadata associated with the first virtual content indicates:
a first context for displaying the first virtual content having the first content locking behavior; and
a second context, different from the first context, for displaying the first virtual content having the second content locking behavior;
displaying the first virtual content having the first content locking behavior is further in accordance with a determination that the electronic device is operating in the first context; and
displaying the first virtual content having the second content locking behavior is further in accordance with a determination that the electronic device is operating in the second context.

20. The non-transitory computer readable storage medium of claim 17, wherein:
the metadata associated with the first virtual content indicates:
at least the first content locking behavior and the second content locking behavior;
a first level of priority for displaying the first virtual content with the first content locking behavior; and
a second level of priority, different from the first level of priority, for displaying the first virtual content with the second content locking behavior.

21. The non-transitory computer readable storage medium of claim 17, wherein the method comprises:
while displaying the first virtual content having the first content locking behavior in accordance with the metadata indicating the first content locking behavior or having the second content locking behavior in accordance with the metadata indicating the second content locking behavior:
detecting that an override criterion is satisfied; and
in response to detecting that the override criterion is satisfied, displaying, via the one or more displays, the first virtual content having a third content locking behavior that is different from the content locking behavior of the first virtual content when satisfaction of the override criterion is detected.

22. The non-transitory computer readable storage medium of claim 21, wherein:
while the first virtual content is displayed having the first content locking behavior or the second content locking behavior that is in accordance with the metadata in response to receiving the request, a user of the electronic device is associated with a first head orientation or a first body orientation; and
the override criterion is satisfied when user input including head rotation or body rotation relative to the first head orientation or the first body orientation, respectively, is detected.

23. The non-transitory computer readable storage medium of claim 21, wherein:
in accordance with a determination that the metadata indicates the first content locking behavior and the first virtual content has the first content locking behavior in response to receiving the request, the third content locking behavior is the second content locking behavior; and
in accordance with a determination that the metadata indicates the second content locking behavior and the first virtual content has the second content locking behavior in response to receiving the request, the third content locking behavior is the first content locking behavior.

24. The non-transitory computer readable storage medium of claim 21, wherein the third content locking behavior is different from the first content locking behavior and the second content locking behavior.
